(19) United States
(12) Patent Application Publication
(10) Pub. No.: US 2010/0248681 A1
(43) Pub. Date: Sep. 30, 2010

(54) METHOD AND SYSTEM FOR PRODUCING EMERGENCY NOTIFICATIONS

(76) Inventor: Anthony Phills, Los Angeles, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/652,316

(22) Filed: Jan. 5, 2010

Related U.S. Application Data
(60) Provisional application No. 61/239,669, filed on Sep. 3, 2009.
(60) Provisional application No. 61/164,026, filed on Mar. 27, 2009.

(51) Int. Cl. H04W 4/22

(52) U.S. Cl. 455/404.2; 455/404.1

(57) ABSTRACT

A method and system for producing an emergency notification based on profile information associated with a subject is disclosed. In one embodiment, an application for a mobile phone or the like allows parents to quickly produce an emergency notification for a missing child. The application may facilitate the collection of the profile information before the subject becomes missing. Consequently, if and when the subject becomes missing, the profile information of the subject has already been collected, allowing prompt generation of an emergency notification in part from the profile information.

### RELATED APPLICATIONS

The present application is a nonprovisional of, claims priority to and incorporates by reference U.S. Provisional Patent Application No. 61/239,669, filed on Sep. 3, 2009 and U.S. Provisional Patent Application No. 61/164,026, filed on Mar. 27, 2009.

### FIELD OF THE INVENTION

The present invention relates to methods and systems for producing an emergency notification and, in one embodiment, comprises an application for a mobile phone or the like, which allows parents to quickly produce an emergency notification for a missing child.

### BACKGROUND

Traditionally, in the unfortunate circumstance when a child becomes missing, the child's parents are expected to immediately contact emergency personnel (e.g., police). The emergency personnel then request the parents to provide information regarding the child, including, e.g., a picture and weight/height of the child. Unfortunately, in the distress and chaos surrounding the circumstance, the parents may not be able to immediately locate a picture of the child, and/or may not correctly recall the weight and/or height of the child. A delay in providing such information regarding the child and/or providing inaccurate information regarding the child may hamper efforts to locate the child.

Likewise, in the unfortunate circumstance when a pet becomes missing, the pet owner(s) may traditionally post posters on telephone poles, and/or send fliers to neighbors. However, upon the disappearance of a pet, a pet owner may not be able to locate a picture of the pet (such as, if no picture were ever taken). Moreover, posting posters on telephone poles and/or sending fliers to neighbors is a slow process and may delay the distribution of news that the pet is missing. Any such delay may likewise hamper efforts to locate the pet.

### SUMMARY OF THE INVENTION

According to one aspect of the present invention, there is provided a computer-readable storage medium storing computer-readable instructions, which instructions, when executed by a processor, cause the processor to perform a process. The process comprises receiving on a mobile device profile information associated with a subject, uploading the profile information from the mobile device to a server, displaying on the mobile device a draft of an emergency notification prepared at the server and based on the uploaded profile information, and transmitting a request from the mobile device to the server for a final version of the emergency notification to be prepared at the server.

According to another aspect of the present invention, there is provided a computer-implemented method, comprising receiving on a mobile device profile information associated with a subject, uploading the profile information from the mobile device to a server, displaying on the mobile device a draft of an emergency notification prepared at the server and based on the uploaded profile information, and transmitting a request from the mobile device to the server for a final version of the emergency notification to be prepared at the server.

According to another aspect of the present invention, there is provided a mobile device, comprising a memory configured to store computer-readable instructions, a network interface device, and a processor communicatively coupled to the memory and the network interface device. When executed by the processor, the computer-readable instructions cause the processor to perform the following process, comprising: receiving on the mobile device profile information associated with a subject; uploading the profile information from the mobile device to a server; displaying on the mobile device a draft of an emergency notification prepared at the server and based on the uploaded profile information; and transmitting a request from the mobile device to the server for a final version of the emergency notification to be prepared at the server.

According to another aspect of the present invention, there is provided a computer-readable storage medium storing computer-readable instructions, which instructions, when executed by a processor, cause the processor to perform a process. The process comprises receiving from a handheld device and at a server, profile information associated with a subject, generating at the server an emergency notification from the profile information, receiving a request from the handheld device and at the server, to transmit the emergency notification, and transmitting from the server the emergency notification so as to facilitate locating the subject.

According to another aspect of the present invention, there is provided a server, comprising a memory configured to store computer-readable instructions, a network interface device, and a processor communicatively coupled to the memory and the network interface device. When executed by the processor, the computer-readable instructions cause the processor to perform the following process, comprising: receiving from a handheld device and at the server, profile information associated with a subject; generating at the server an emergency notification from the profile information; receiving a request from the handheld device and at the server, to transmit the emergency notification; and transmitting from the server the emergency notification so as to facilitate locating the subject.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a system in which the present invention may be used, according to an embodiment of the invention;

FIG. 2 illustrates a method of producing an emergency notification, according to an embodiment of the invention;

FIG. 3 illustrates a flow chart describing the transfer of electronic files to a mobile device, according to an embodiment of the invention;

FIG. 4 illustrates an example of a user interface for a mobile device facilitating the log in of a user to an account, according to an embodiment of the invention;

FIG. 5 illustrates an example of a user interface for a computing device facilitating the input of various user information, according to an embodiment of the invention;

FIG. 6 illustrates an example home screen for an application on a mobile device, according to an embodiment of the invention;

FIG. 7 illustrates examples of user interfaces for a mobile device facilitating the input of one or more subject profiles, according to an embodiment of the invention;

FIG. 8 illustrates an example of a user interface for a mobile device facilitating the input of further profile information, according to an embodiment of the invention;

FIG. 9 illustrates examples of user interfaces for a mobile device facilitating the input of one or more emergency contacts' contact information, according to an embodiment of the invention;

FIG. 10 illustrates examples of user interfaces for a mobile device facilitating the update of profile information, according to an embodiment of the invention;

FIG. 11 illustrates an example of a user interface for a computing device facilitating the log in of the user, according to an embodiment of the invention;

FIG. 12 illustrates an example of a user interface for a computing device facilitating the upload of electronic files to a server, according to an embodiment of the invention;

FIG. 13 illustrates examples of user interfaces for a mobile device facilitating the download of an electronic file from a server to the mobile device, according to an embodiment of the invention;

FIG. 14 illustrates examples of user interfaces for a mobile device facilitating the display of downloaded electronic files, according to an embodiment of the invention;

FIG. 15 illustrates the display of a dental record and a fingerprint record on a mobile device, according to an embodiment of the invention;

FIG. 16 illustrates examples of user interfaces for a mobile device facilitating the display of safety tips, according to an embodiment of the invention;

FIG. 17 illustrates examples of user interfaces for a mobile device facilitating the preview and printing of a poster corresponding to a missing subject, according to an embodiment of the invention;

FIG. 18 illustrates examples of user interfaces for a mobile device facilitating the upload of a poster to a server, and allowing the server to notify the user that a poster is ready to be printed, according to an embodiment of invention;

FIG. 19 illustrates an example of a poster that may be displayed on a computing device, according to an embodiment of the invention;

FIG. 20 illustrates an example of an emergency notification template, according to an embodiment of the invention;

FIG. 21 illustrates examples of user interface screens facilitating the alerting of various parties regarding a missing subject, according to an embodiment of the invention;

FIG. 22 illustrates an example of a user interface facilitating the alerting of various parties regarding a missing subject, according to an embodiment of the invention;

FIG. 23 illustrates a further example of a user interface facilitating the alerting of various parties regarding a missing subject, according to an embodiment of the invention;

FIG. 24 illustrates examples of user interfaces facilitating the posting of one or more alerts, according to an embodiment of the invention;

FIG. 25 illustrates an example of a user interface facilitating the generation of a police report, according to an embodiment of the invention;

FIG. 26 illustrates further examples of user interfaces facilitating the generation of a police report, according to an embodiment of the invention;

FIG. 27 illustrates an example of a police report that may be displayed on a computing device, according to an embodiment of the invention;

FIG. 28 illustrates a computing system (including components therein), configured for operation according to an embodiment of the invention; and

FIG. 29 illustrates an example of identification cards being produced from an uploaded profile, in accordance with embodiments of the present invention.

### DETAILED DESCRIPTION

The present invention provides systems and methods for creating and managing emergency notifications concerning missing children, pets, or others. In various embodiments, the invention is particularly useful with mobile devices, such as mobile phones and the like, but can also be used with personal computers and the like. Conveniently, the invention allows parents, pet owners and others to prepare emergency notifications quickly, in some cases using previously stored profile information concerning the missing subject. In this way, the invention facilitates the rapid dissemination of information concerning the missing subject.

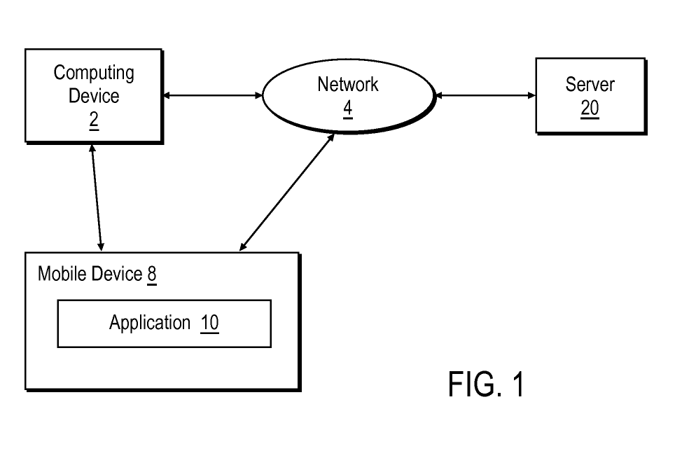

FIG. 1 illustrates a system in which the present invention may be used. In one embodiment, aspects of the present invention may be instantiated as application 10 for a mobile device 8, such as a mobile phone (e.g., an iPhone™ available from Apple, Inc. of Cupertino, Calif.), personal digital assistant, personal computer, or similar instrument. That is, aspects of the present invention may be implemented as computer-readable instructions stored on a computer-readable storage medium, which instructions, when executed by a processor, perform and/or facilitate (e.g., in the case of user activities) the operations described herein. Portions of the processes discussed herein may be performed in a distributed computing environment, wherein certain activities are performed at or by a remote processor (at, e.g., mobile device 8) while other functions are performed at one or more servers 20 or other hosts that are communicatively coupled to the remote processor by a wired and/or wireless network or networks 4, such as the Internet or Mobile Web.

In one embodiment, the application may be downloaded to mobile device 8 from a host other than that at which the processing of requests for the preparation of emergency notifications takes place. For example, the application may be downloaded from an electronic commerce site such as Apple's App Store™ for iPhone applications. Alternatively or in addition, the application may be downloaded to computing device 2, such as a personal or client computer, and then uploaded to mobile device 8 as part of a synchronization process between computing device 2 and mobile device 8.

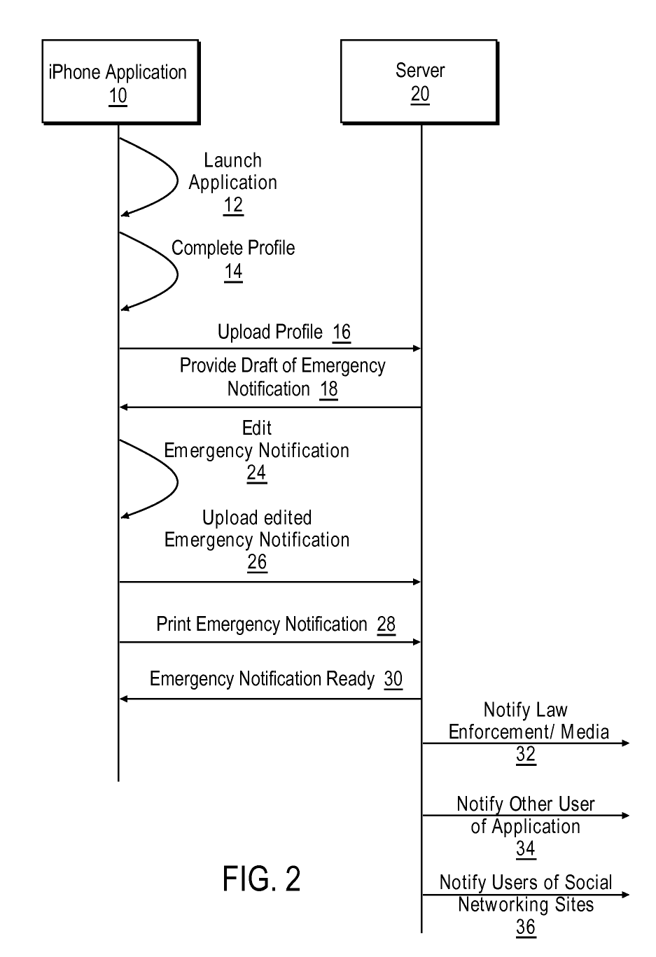

FIG. 2 illustrates an example of an exchange of communications between mobile device 8 at which application 10 is executing and one or more servers 20 at which requests for the preparation of emergency notifications are processed. First, a user (typically a parent or other adult) may use a browser, for example a Wireless Application Protocol (WAP) browser, to access network 4, for example the Internet or a Mobile Web, and launch application 10 (step 12) from mobile device 8. Alternatively, application 10 may be launched locally on mobile device 8 and not require access to network 4 for the launching of application 10. Upon launching application 10, a user may be presented with a log in page for (1) the user to input user identification and password information, and (2) the application to authenticate the user.

As shown in FIG. 2, when application 10 is resident on mobile device 8 and is running (e.g., application 10 has been launched (step 12)), and optionally the user has successfully logged in to application 10, the user may use application 10 to create and/or complete a profile of a human (e.g., child), pet or other item (step 14). Other human subjects include adults, including the elderly with impairments (e.g., Alzheimer's, dementia, etc.) It is noted the present invention can be used to produce alert notifications regarding any subject matter. The profile can include any relevant information regarding (and/or that may help identify or locate) the subject thereof, for example in the case of a human, the profile can include (qualitative and/or quantitative) information regarding the human's age, gender, height, weight, body type/build, eye color, skin complexion, ethnicity, identifying scars or marks, tattoos, piercing, disabilities, blood type, medications, allergies, parents' or guardians' contact information, emergency contacts' contact information, etc. For a pet (or more generally an animal), the profile might include information regarding the species of animal, breed, sex, license identification number, radio frequency identification tag number, owner's name and contact information, veterinarian's contact information, etc. For an inanimate object, the profile may include information regarding the object such as its type, kind, color, weight, chemical composition, etc. For an inanimate object such as an automobile, the profile may include information such as license plate number, model, make, Vehicle Identification Number (VIN), etc.

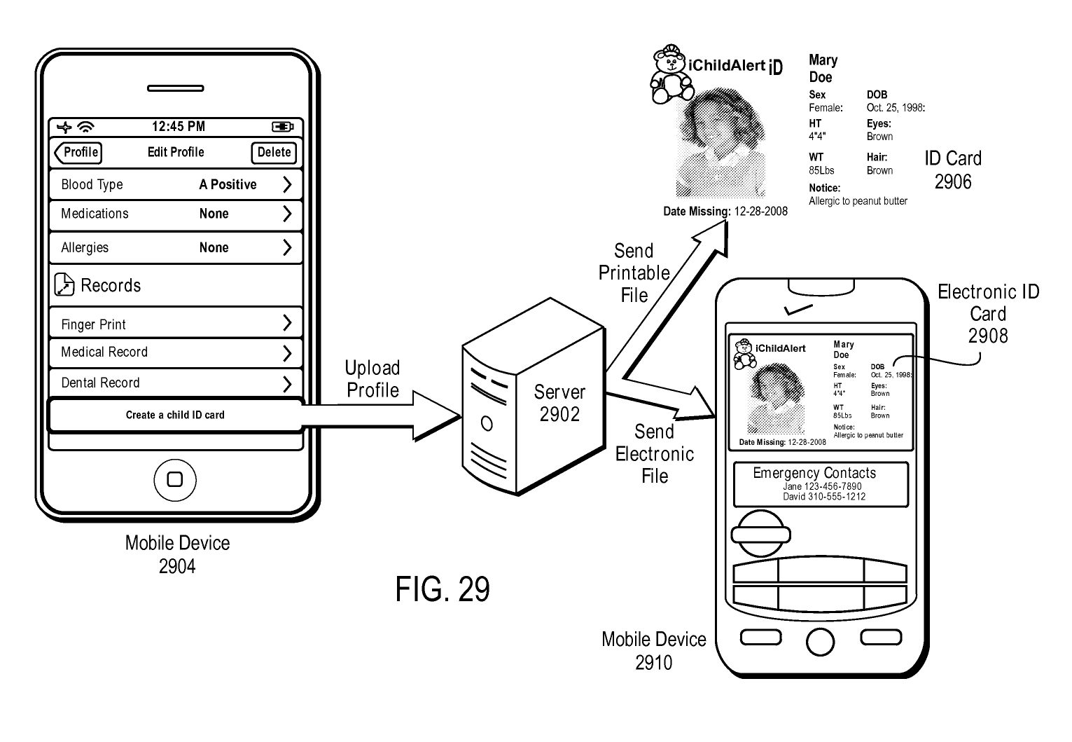

In some instances, once a profile has been created, the server may return identification cards to the mobile device. As shown in FIG. 29, the profile may be uploaded to a server 2902 from a mobile device 2904 and, in response, the server may prepare, based on the profile information, and return a file (such as a Portable Document Format file) containing a printable identification card 2906 for the subject of the profile. The server may also distribute electronic identification cards 2908 to mobile device 2904 and/or other mobile devices 2910 (e.g., those used by friends and family of the creator of the profile and/or the subject of the profile). The electronic identification cards may be in any format, including vcards or other electronic files or documents.

Returning to FIG. 2, Information regarding the subject of a profile may be input to application 10 using the user interface of mobile device 8. In the case of an iPhone, a touch-screen display may be utilized to input characters, control a cursor of the iPhone, as well as select user interface elements. In the case of a Blackberry™, available from Research In Motion™, a keypad and/or trackball may be utilized to input characters, control a cursor, as well as select user interface elements. Alternatively, or in addition, information regarding the subject may be input using computing device 2 and transferred to mobile device 8. In one embodiment of the invention, information regarding the subject may be transferred directly from computing device 2 to mobile device 8 using, for example a wired and/or wireless connection from computing device 2 to mobile device 8. In another embodiment of the invention, information regarding the subject may be transferred (e.g., uploaded) from computing device 2 to one or more servers 20 and subsequently transferred (e.g., downloaded via MMS, SMS, etc.) from one or more servers 20 to mobile device 8, after which the information regarding the subject is made available to application 10.

In the case where the information regarding the subject is first transferred to one or more servers 20, the information may be stored on one or more servers 20 and made available for download from one or more servers 20 for a finite duration of time (e.g., two hours, one day, three days, one month, etc.) from the time at which the information is uploaded to one or more servers 20. After this finite duration of time has elapsed, such information may be permanently deleted from one or more servers 20, after which the user may need to re-upload such information to one or more servers 20, in the event that such information has not been already downloaded from one or more servers 20 to mobile device 8. Alternatively or in addition, the information may be automatically downloaded (e.g., without any additional user action required) to mobile device 8 upon being uploaded to one or more servers 20. This latter case is especially useful in situations where a user has previously established an account with a service providing the features discussed herein and has authorized such automatic updates or synchronization between the server and the mobile device.

In one embodiment of the invention, an electronic file that includes information associated with or relevant to the subject may be associated with the subject's profile. The electronic file may include a digital image or video of the subject, such that if the subject were missing, the digital image or video may assist one or more individuals (e.g., law enforcement officers, detectives, friends, parents, members of the general public, etc.) in locating and/or identifying the missing subject. A digital image may include a frontal and/or side view of the subject's head so as to depict facial features of the subject. A digital image may also include a frontal and/or side view of the subject's body so as to depict body proportions, posture, etc. A video of the subject may include visual and/or audio information regarding the subject. For example, the laugh or giggle of a child, or the visual image of a child skipping across the street may jog the memories of individuals, and assist in locating and/or identifying the missing subject. In some cases, the electronic file may include an audio/video stream with both audio and visual information, an image stream without audio, as well as an audio stream without images.

In another embodiment of the invention, one or more electronic files associated with the subject may store electronic versions of fingerprint records, medical records (e.g., X-Rays, Computer Tomography-Scans, Magnetic Resonance Images), and/or information concerning the DNA sequence of the subject. In particular, an X-Ray of the subject may include dental X-Rays, which can be used to identify a subject in the event teeth/jaw information is located. An X-Ray of the subject may also include a skeletal X-Ray, which can be used to identify a subject in the event bone and/or bone fragments are located. The DNA sequence of the subject can be used to identify a subject in the event bodily fluids (e.g., blood, saliva, etc.) or body tissue/matter are located.

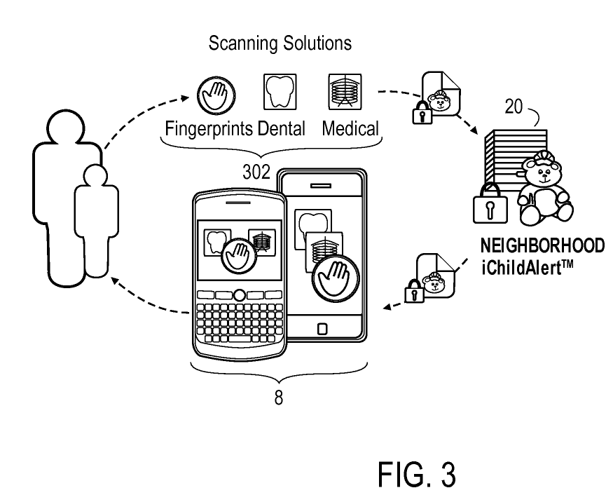

The electronic file (e.g., digital image) may be one that was previously stored on mobile device 8 (e.g., a previously stored image available from the mobile phone's photo album) or it may be created by mobile device 8 (e.g., a digital image captured at the time the profile is being completed, for example using the mobile phone's camera, if so equipped). Alternatively or in addition, the electronic file may be first stored on computing device 2 before being transferred to mobile device 8. In one embodiment of the invention, the electronic file may be transferred directly from computing device 2 to mobile device 8 using, for example a wired and/or wireless connection from computing device 2 to mobile device 8. In another embodiment of the invention, the electronic file may be transferred (e.g., uploaded) from computing device 2 to one or more servers 20 and subsequently transferred (e.g., downloaded via MMS or other communicative means, etc.) from one or more servers 20 to mobile device 8, after which the electronic file is made available to application 10. This process is also depicted in FIG. 3, in which electronic files 302 (e.g., fingerprint records, dental records and medical records) are securely uploaded to one or more servers 20, and subsequently securely downloaded from one or more servers 20 to mobile device 8 (e.g., a Blackberry or iPhone).

In the case where the electronic file is transferred to one or more servers 20, the electronic file may be stored on one or more servers 20 and made available for download from one or more servers 20 for a finite duration of time (e.g., two hours, one day, three days, one month, etc.) from the time at which the electronic file is uploaded to one or more servers 20. After this finite duration of time has elapsed, the electronic file may be permanently removed from one or more servers 20, after which the user may need to re-upload the electronic file to one or more servers 20, in the event that the electronic file has not been already downloaded from one or more servers 20 to mobile device 8. Alternatively or in addition, the electronic file may be automatically downloaded (e.g., in the manner discussed above) to mobile device 8 upon being uploaded to one or more servers 20.

An electronic file may be associated with a profile through one or more of the following techniques: A user may manually navigate to a user interface screen which allows attaching an electronic file to a profile. Alternatively, or in addition, application 10 may automatically associate an electronic file labeled with a subject name with a profile with the same subject name. Alternatively, or in addition, a user may complete some or all of the textual fields associated with a profile (via, e.g., computing device 2 or mobile device 8), submit such information to server 20, at which time application 10 or a Web application may prompt a user to submit one or more electronic files (e.g., digital image of a subject, dental records, fingerprint records, etc.) to server 20. In the case where one or more digital images are present on mobile device 8, the digital image(s) can be sent (via, e.g., MMS) from mobile device 8 to server 20. Subsequently, server 20 may attach the digital image(s) to a profile of a subject, and send the profile with the attached digital image(s) to mobile device 8. In the case where one or more electronic files (e.g., digital image of a subject, dental records, fingerprint records, etc.) are present on computing device 2, these electronic file(s) can be submitted (e.g., uploading via a web portal) to server 20. Subsequently, server 20 may attach the electronic file(s) to a profile of a subject, and send a profile with the attached electronic file(s) to mobile device 8. After mobile device 8 has received the profile with the attached electronic file(s), all information (profile and/or electronic file(s)) related to the subject may be deleted from server 20.

Preferably, the profile information and the association of an electronic file with the profile is performed well in advance of (and/or before) the need to have an emergency notification prepared. To elaborate, it is possible that when the subject becomes missing (e.g., a child is abducted), the user may not recall and/or may not have readily available the profile information and electronic file(s) associated with the missing subject. This scenario may occur, for example, if a user were traveling on vacation, on a business trip, or visiting friends. Having input profile information and electronic file(s) well in advance of the need to prepare an emergency notification can help prevent such an unfortunate circumstance. Alternatively, or in addition, profile information and electronic file(s) may be input after the subject becomes missing.

Some time after the profile has been completed, it is uploaded (step 16) from mobile device 8 to server 20. Preferably, this is done only after a need for an emergency notification exists, however, in some embodiments the profile may be stored on server 20 before any such needs exists and accessed at some time thereafter. If in fact the profile is stored on server 20, computing device 2 may be used to access/update the profile stored on server 20. Alternatively, if the profile is stored at mobile device 8, computing device 2 may be used to access/update the profile stored at mobile device 8 (either through a direct connection to mobile device 8 or an indirect connection to mobile device 8 through server 20).

Server 20 responds to the uploading of the profile (or other indication of the need for preparation of an emergency notification) by providing a draft of the emergency notification (step 18). This may be in the form of a draft of a poster or other notification advising of the status of the missing subject. The draft emergency notification may include editable fields for the parent or other user of the mobile phone/application to provide further details regarding the status of the subject of the notice. For example, in the case of a missing child or pet, the user may be prompted (e.g., by the presence of editable fields) to provide information (step 24) regarding the circumstances of the child's/pet's disappearance, time and date of disappearance, place where last seen, clothing worn at the time of disappearance, other emergency contacts, police report information, etc. In particular, the place the subject was last seen may be provided by the selection of a location on a map, input of an address, and/or input of latitude/longitude coordinates. The user may also be provided the opportunity to update any previously stored profile information, including adding new photos, etc. For an inanimate object, details regarding the object's disappearance can be provided.

When the emergency notification has been completed, or when as much information as possible has been provided, the user uploads the information from mobile device 8 to server 20 (step 26), for example by selecting or activating an appropriate user interface element. Thereafter, the user may instruct server 20 to prepare the emergency notification (e.g., a poster or the like) using the profile and other information (step 28). Again, this may be done by selecting or activating an appropriate user interface element, or it may be done automatically in response to the user uploading the edited profile information. Thereafter, server 20 will prepare the emergency notification (e.g., a poster or similar item) and advise the user via email, short message service (SMS) message or other means (e.g., a telephone call to the mobile phone, etc.) that the emergency notification is ready for retrieval from the server (step 30). In the case of an email notification, the email message from the server may include a hyperlink to a copy of the emergency notification which can be downloaded and printed by the user. The emergency notification may include a map indicating where the child/pet/subject was last seen.

In other instances, the emergency notification may take the form of a web site prepared by server 20 and made available at a particular web address (URL). In such cases, the user will be notified of the web address of the new emergency notification and that web address can then be provided to the media, law enforcement and other information dissemination channels. Further, server 20 may send (automatically, or in response to user input) copies of the emergency notification (or other forms thereof, e.g., RSS feeds, e-mail alerts, SMS messages etc.) to law enforcement and/or media outlets (step 32). This may be done before, after or in parallel with notifying the user of the availability of the emergency notification.

In another embodiment of the invention, server 20 may send (automatically, or in response to user input) copies of the emergency notification to one or more other users of application 10 (step 34), and/or one or more users of a social networking website (step 36). For brevity in notation, one or more other users of application 10 will be called “other application users”, and one or more users of a social networking website will be called “social networking users”. Some example social networks are Facebook, MySpace, Digg and Twitter, to name a few. It is understood that the aforementioned other application and/or social networking users may or may not be users of both application 10 and a social networking website.

The sending (e.g., broadcast) of the emergency notification to the other application and/or social networking users may be filtered and/or restricted based on geographical information, temporal information and/or relational information. In the case of geographical filtering, the emergency notification may be, for example, sent to only other application and/or social networking users who live in a geographic area delimited by one or more ZIP codes, one or more cities, geometric shapes (such as circles, squares, etc.), etc. The geographic area may be chosen based upon, for example, the location the missing subject was last seen, the suspected location of the missing subject, the location of one or more individuals suspected in the disappearance of the missing subject, an address of the missing subject, or an address of the user of application 10.

In the case of temporal filtering, the emergency notification may be, for example, sent to only other application and/or social networking users who interacted with the missing subject, or user of application 10 within a certain window of time. For example, the missing subject may have communicated with 10 people on a social networking website within the 24 hours prior to being reported missing. It would be desirable to send the emergency notification to this group of individuals who last communicated with the missing individual and who may know the missing subject's whereabouts. As another example, the user of the application may have communicated with 100 social networking users within the last year before the missing subject became missing. It would be desirable to send the emergency notification to this group of individuals who the user has had recent contact with, and are more likely to remember or care about the user and, accordingly, the missing subject.

In the case of relational filtering, the emergency notification may be, for example, sent to only other application and/or social networking users who are “friends” of the missing subject, and/or user of application 10 (i.e., other application and/or social networking users who have some association with the missing subject and/or user of application 10). The relational filtering may be more selective than sending the emergency notification to all friends, and instead, may only send the emergency notification to a certain category of friends, such as family, friends from kindergarten, friends from elementary school, friends from middle school, friends from high school, friends from college, co-workers, etc. Yet another category of friends could also factor in temporal information, such as only friends and/or a user of application 10 who have interacted with the missing subject at least a certain number of times within a certain window of time. The relational filtering may be less restrictive than sending the emergency notification to only friends of the missing subject and/or user of application 10, and instead may also send the emergency notification to friends of the friends of the missing subject and/or user of application 10, and so on.

In another embodiment of the invention, the emergency notification may be sent to people other than application and social networking users. These people include any computer users with Internet access and/or any people with a mobile device. As will be described later, these people also include people in the media as well as locating individuals, including law enforcement officers. The geographical, temporal and relational filtering techniques mentioned above may also be similarly applied to people other than application and social networking users.

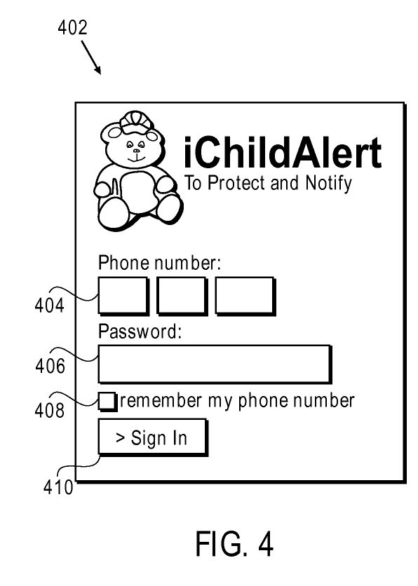

FIGS. 4-27 are examples of various user interfaces associated with an application configured in accordance with the present invention. FIG. 4 depicts an example log in user interface 402 including, e.g., textboxes 404 and 406 for the user to input his/her user identification and password, respectively, using mobile device 8. User identification information may include the user's phone number, as depicted in FIG. 4, or user name, customer number, social security number or other identification of the user. The user may allow application 10 to remember his/her user identification through, for example, the selection of check box 408 as depicted in FIG. 4. Selection of an appropriate user interface element (e.g., Sign In button 410) submits the user identification and password, as well as other user input, to application 10.

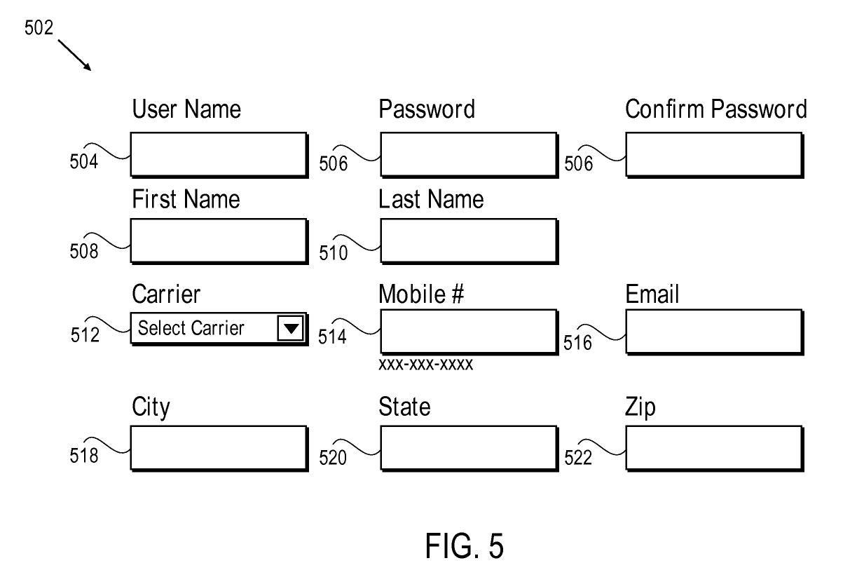

If however the user is a new user without an existing account, the user may sign up for an account using computing device 2, in which case, a user interface screen, such as that depicted in FIG. 5 (element 502), may be presented to the user via computing device 2. Textboxes and/or drop-down menus 504, 506, 508, 510, 512, 514, 516, 518, 520 and 522 of user interface screen 502 allow the user to input a user name, password, first and last name of the user, mobile telephone service carrier, mobile telephone number, e-mail address, and city/State/ZIP of the user's address respectively. Alternatively or in addition, new users may sign up for an account using mobile device 8, through a similar user interface screen (not illustrated).

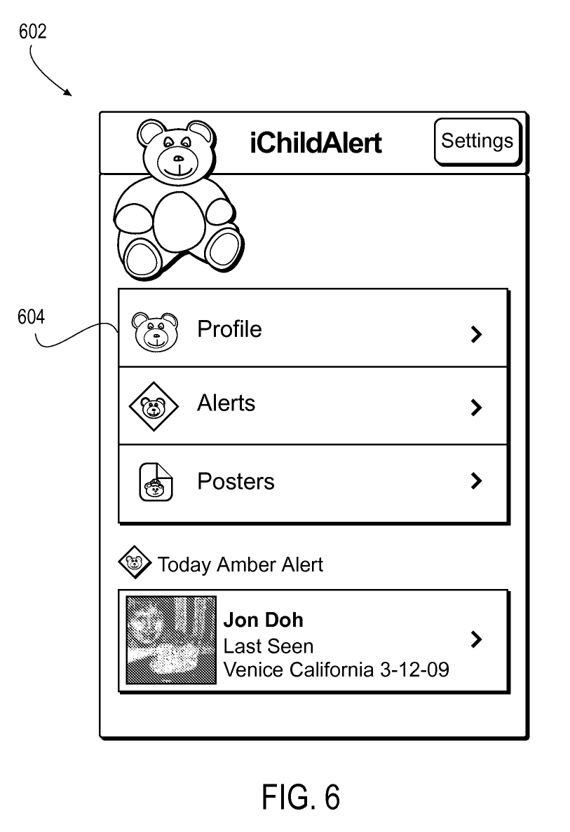

FIG. 6 shows home screen 602 for application 10 as resident on mobile device 8, which may be presented to the user upon successful log in. Selecting Profile button 604 on the home screen may navigate the user to a list of available profiles 702 stored on the device. This is also where the user may create a new profile, by selecting an appropriate user interface element.

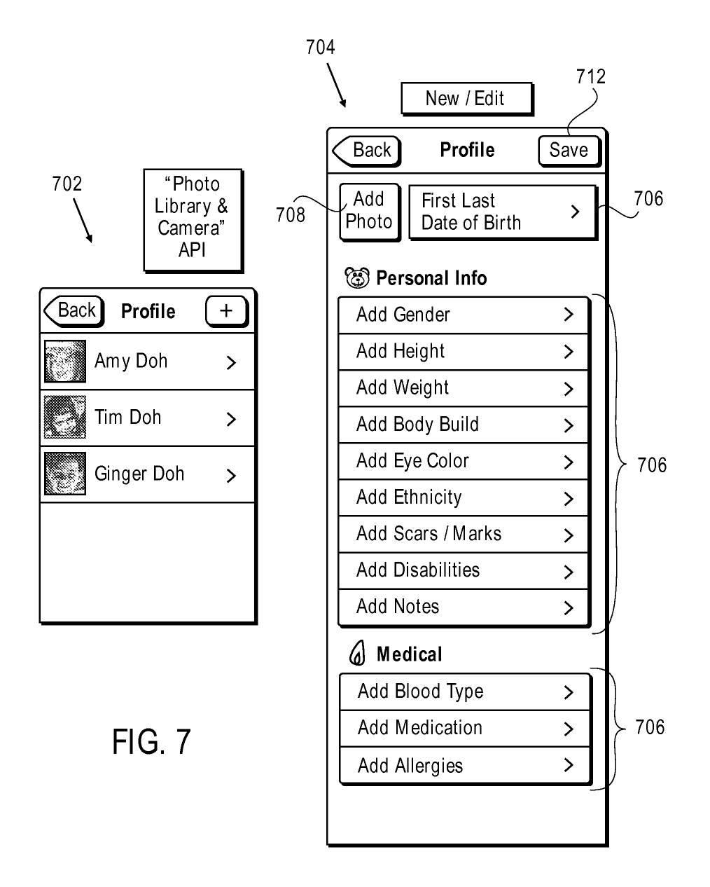

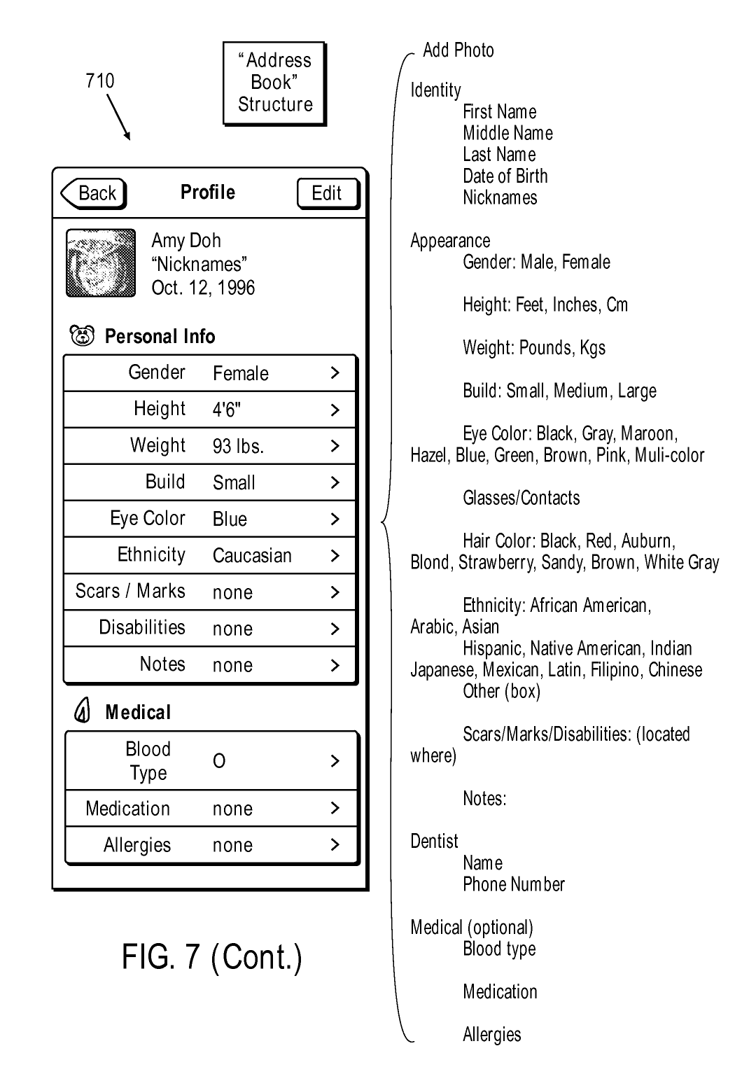

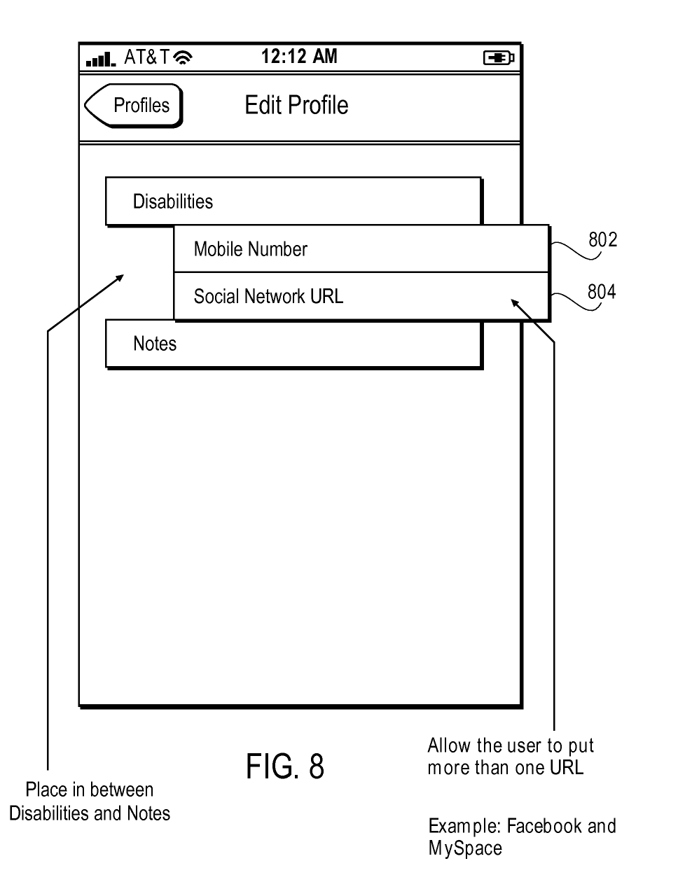

New profile screen 704 is also shown in FIG. 7 and provides regions 706 and 708 where a user can enter information regarding the subject and also attach a digital image of the subject, respectively. The information may be entered as text, or by selecting appropriate entries from a pre-populated list. For example, physical characteristics such as height, weight, build, eye color, hair color, etc. can be entered in corresponding fields. Likewise, characteristics such as gender, ethnicity, identifying marks, etc. can be entered in appropriate fields. A completed profile 710 is also shown in FIG. 7. In some cases, profiles may include medically relevant information such as allergies, blood type, medications, whether or not the human subject (e.g., child) wears glasses or contact lenses, etc. Such medical information may be provided to medical personnel, in the event the subject is found and requires medical attention. In other cases, profiles may include one or more mobile numbers of the subject 802, one or more social network Uniform Resource Locators (URLs) 804 of the subject, as depicted in FIG. 8, as well as the subject's land-line number(s), work number(s), address(es), etc.

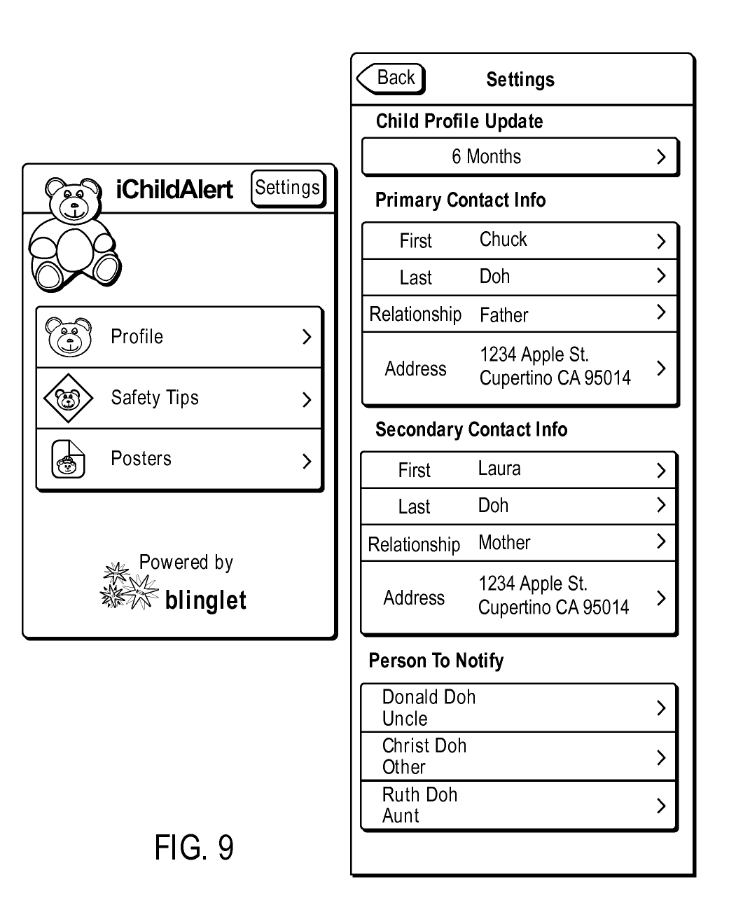

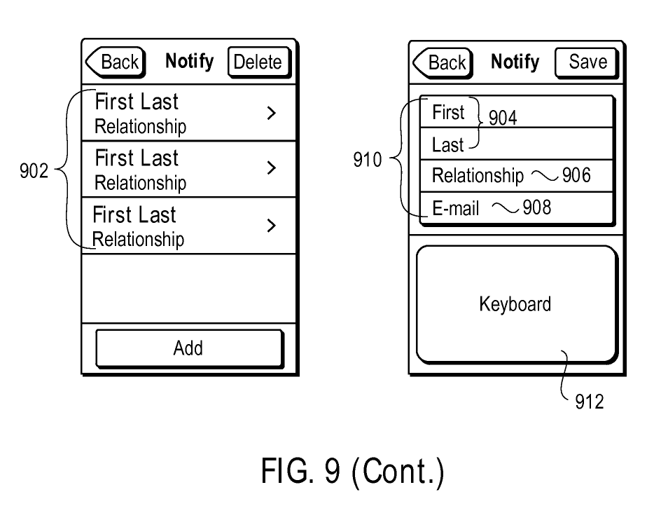

Once this portion of the profile has been completed, the user may save the profile (using, for example, Save button 712) and then, as shown in FIG. 9, is provided various user interface elements 902 to input emergency contact information for the subject in the profile. Emergency contact information may include the name, relationship, email address (to be input via, e.g., editable fields 904, 906 and 908 respectively) telephone numbers and street addresses of one or more individuals to be contacted in the event of an emergency. Such emergency contact information may be used in the event the subject is found by emergency personnel, and the emergency personnel seeks to contact individuals associated with the subject. Moreover, FIG. 9 shows how in the case of an iPhone, selecting a particular field for a profile or a notification contact will produce an editable version of that field 910 along with the device's virtual keyboard 912, allowing the user to enter the requested information. Alternatively or in addition, information can be input from computing device 2 and subsequently transferred to mobile device 8 (through any of the above-mentioned transferring techniques, e.g., direct transfer from computing device 2 to mobile device 8, or transfer from computing device 2 through server 20 to mobile device 8) to populate fields of the profile.

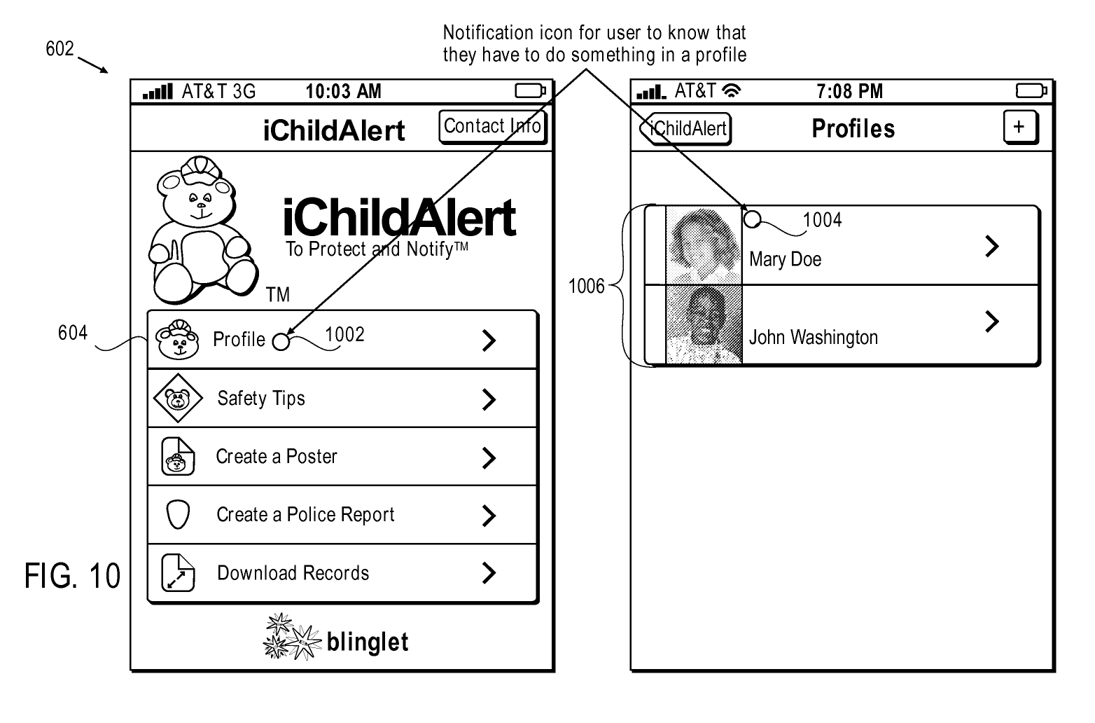

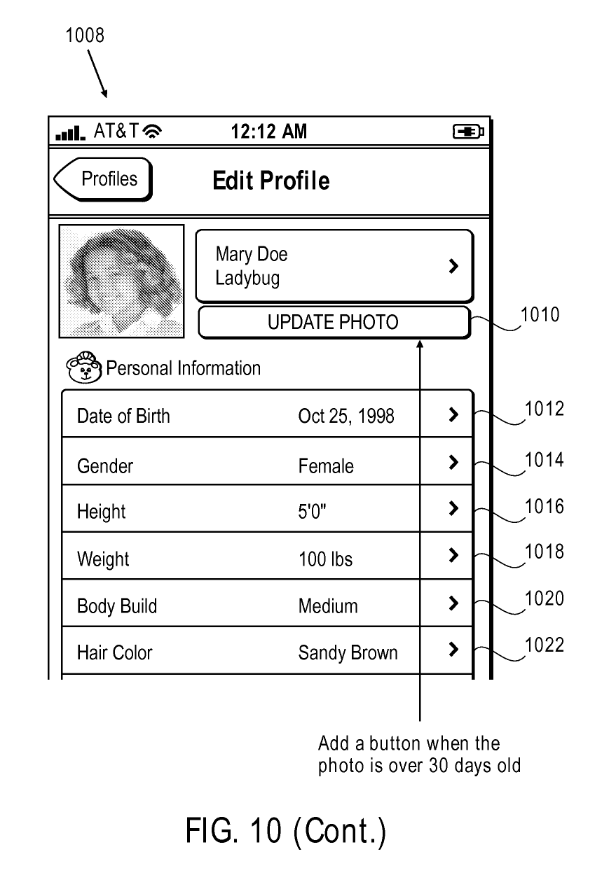

Once a profile has been completed, alerts can be set to automatically remind the user to update the profile at periodic intervals. As illustrated in FIG. 10, a user interface element, such as notification icons 1002 and 1004, may appear in the user interface screen alerting the user to update one or more profiles. For example, in FIG. 10, notification icon 1002 appears within Profile button 604 displayed in home screen 602. Upon selecting Profile button 604, or other user interface element, list of profiles 1006 may be displayed (by application 10) in which notification icon 1004 may appear with one or more profiles that require updating. Upon selecting a profile that requires updating, the user may be presented with screen 1008 that permits the various aspects of the profile to be updated. For example, Update Photo button 1010, or other user interface element, may allow the user to update a digital image of the subject. Update Photo button 1010 may always be available to the user to update a digital image of the subject, or alternatively, Update Photo button 1010 may become available only when the digital image has been stored for over a certain time period. In addition, information related to the subject, such as for example date of birth, gender, height, weight, body build and hair color may be updated via user interface elements 1012, 1014, 1016, 1018, 1020, and 1022 respectively.

FIGS. 11-15 illustrate example user interface screens associated with the transfer of an electronic file from computing device 2 to mobile device 8. As depicted in FIG. 11, a user of computing device 2 may interact with a Web application, possibly distinct from application 10, through user interface screen 1102 with example textboxes 1104 and 1106 that permit entry of a user identification and password respectively. The user may allow Web application to remember his/her user identification through, for example, the selection of check box 1108 as depicted in FIG. 11. Selection of an appropriate user interface element (e.g., Sign In button 1110) submits the user identification and password, as well as other user input, to the Web application.

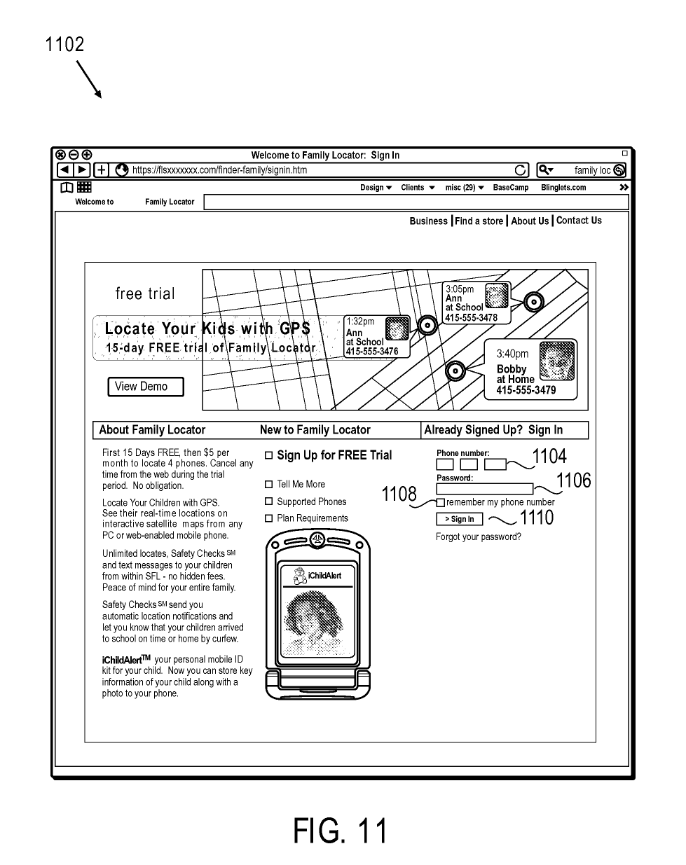

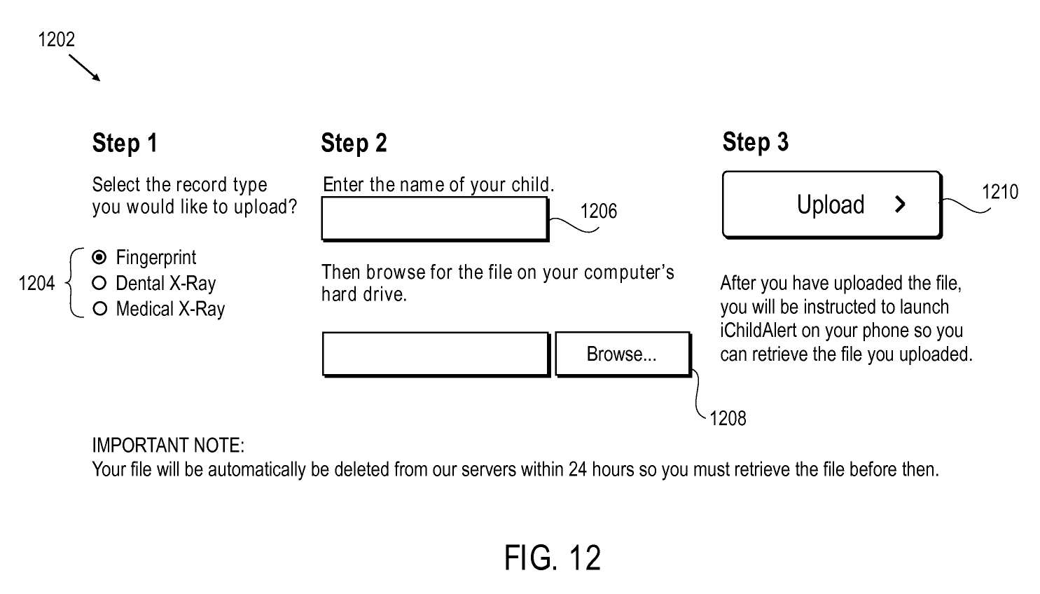

Upon successful log in to the Web application, the user may be presented with a user interface, such as that depicted in FIG. 12 (element 1202), to upload an electronic file. As illustrated in FIG. 12, a user may select (via, e.g., radio buttons 1204) a type of electronic file (e.g., fingerprint record, dental X-Ray record and/or medical X-Ray record) that the user desires to upload. Additionally, the user may enter (via, e.g., textbox 1206) the name of the subject (e.g., child) with whom the electronic file is associated. The user may select an appropriate user interface element (e.g., Browse . . . button 1208) to browse and locate an electronic file on a data store associated with computing device 2. Upon locating the desired electronic file(s) to upload, a user may select an appropriate user interface element (e.g., Upload button 1210) to upload the desired electronic file(s) to server 20. As mentioned above, the electronic file uploaded to server 20 may be deleted from server 20 within a predetermined period of time (e.g., 24 hours), consequently providing the user a predetermined period of time during which the uploaded electronic file may be downloaded to mobile device 8.

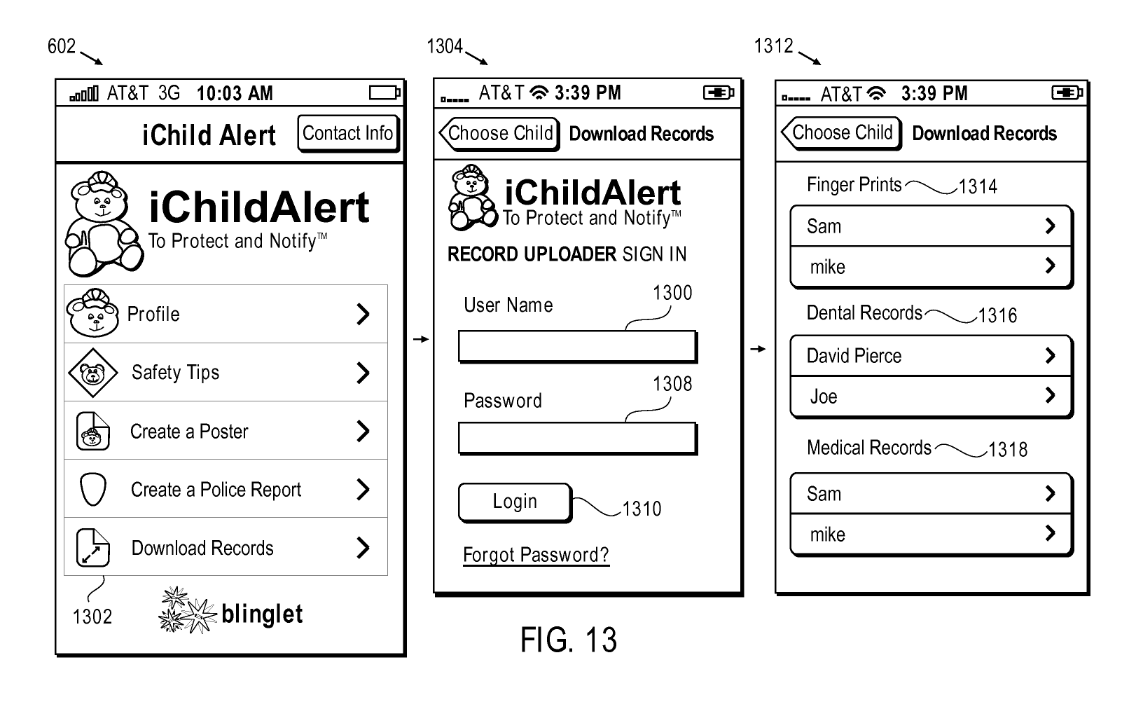

FIG. 13 illustrates example user interface screens which may appear on mobile device 8 to facilitate downloading the electronic file from server 20 to mobile device 8. From home screen 602, the user may select Download Records button 1302, or other user interface element, which may result in the display of a log in screen (e.g., screen 1304 with text boxes 1306 and 1308) for the user to input a user identification and password respectively. Upon inputting a user identification/password, selecting an appropriate user interface element (e.g., Login button 1310), and successfully logging in, the user is presented with a user interface screen (e.g., screen 1312) which allows one or more electronic files to be selected for downloading from server 20. As depicted in FIG. 13, the electronic files available for downloading may be grouped by record type (using, e.g., Finger Prints heading 1314, Dental Records heading 1316 and Medical Records heading 1318); alternatively, the electronic files may be grouped by subject name (not illustrated).

Upon successful download of electronic files from server 20 to mobile device 8, the electronic files may be (automatically or manually) associated with a profile. For example, a user may manually select a certain electronic file to be associated with a certain profile. Alternatively or in addition, application 10 may automatically associate an electronic file labeled with a subject name with a profile with the same subject name.

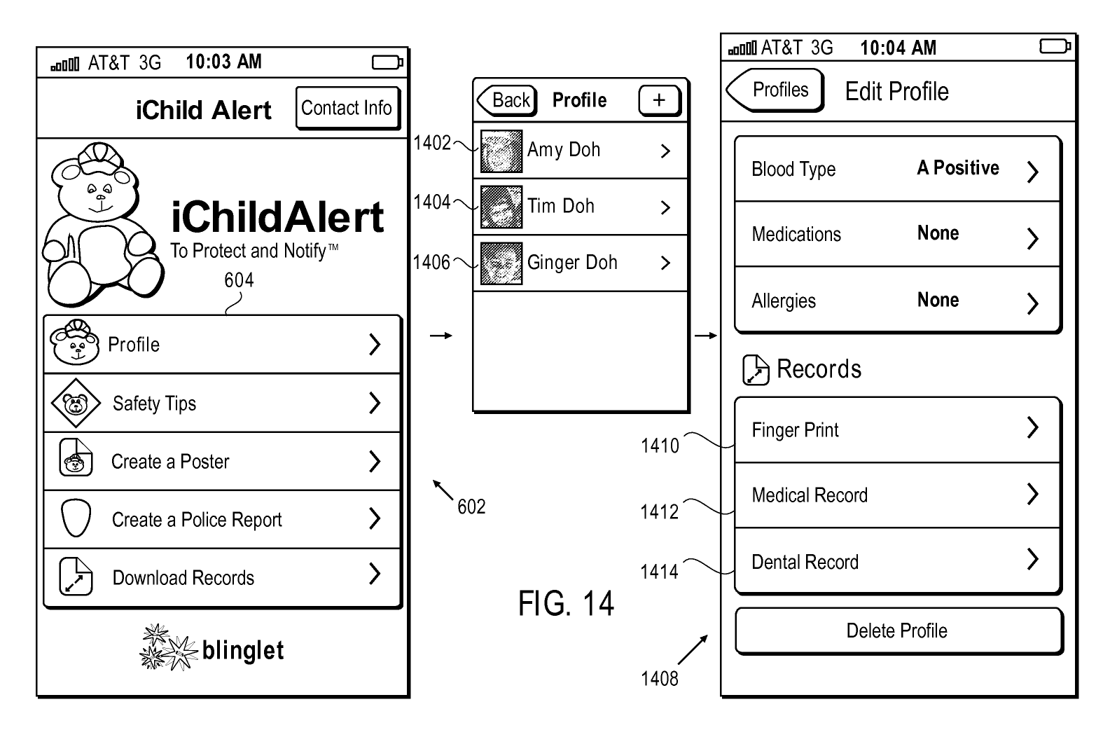

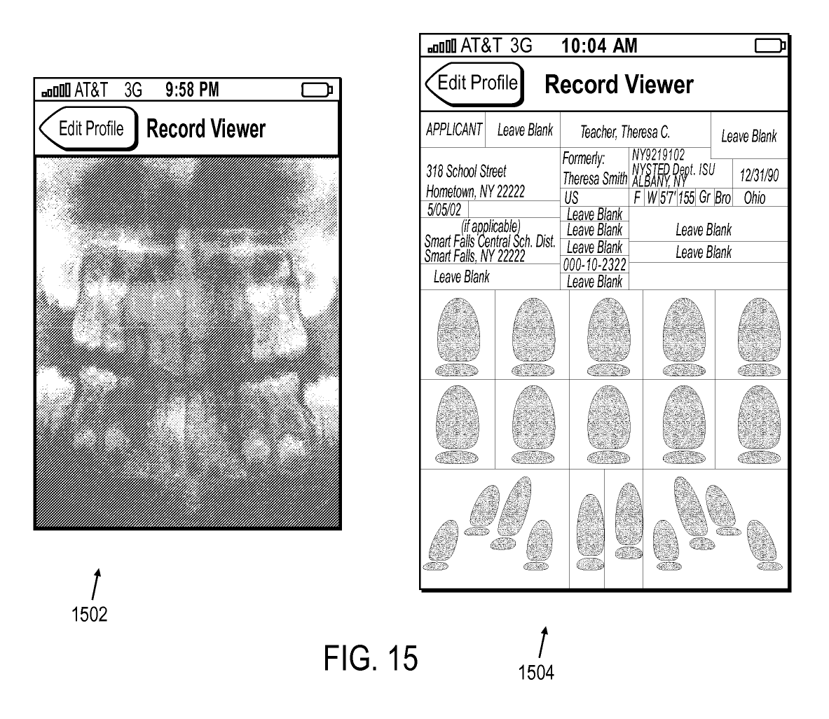

Once an electronic file has been associated with a profile, the electronic file may be viewed by the user, as illustrated by the example user interface screens depicted in FIGS. 14-15. From home screen 602, a user may select Profile Button 604, or other user interface element, followed by selecting a button (e.g., 1402, 1404 and 1406) corresponding to particular subject's profile. Next, a user interface screen (e.g., 1408) may appear allowing a user to select an electronic file to view (via, e.g., buttons 1410, 1412 and 1414). FIG. 15 depicts an example X-Ray dental record 1502 and fingerprint record 1504 that way be displayed by application 10.

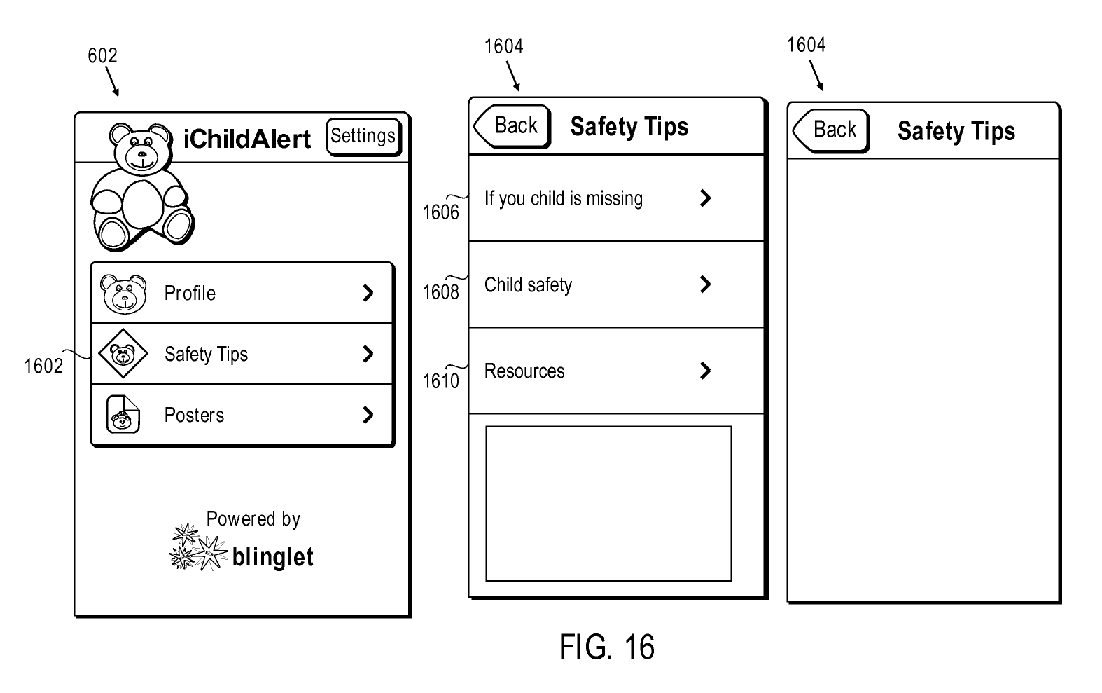

FIG. 16 illustrates an example of user interface screens relating to safety tips. From home screen 602, the user can navigate (via, e.g., button 1602) to one or more screens where safety tips and other information are provided. This may be static or dynamic information. For example, the safety tips (or another portion of the user interface) may include an area where the user can review information regarding other missing children, pets, etc. For example, the server may broadcast information to users of this application (who register with the service) whenever a new emergency notification is created. This way, community-based notifications can be provided regarding missing children, pets, etc. In addition, user interface screens 1604 may allow a user to access static information regarding what to do in the event that a subject becomes missing (via, e.g., user interface element 1606), what precautions a user may take to prevent a subject from becoming missing (via, e.g., user interface element 1608), as well as other safety information (via, e.g., user interface element 1610).

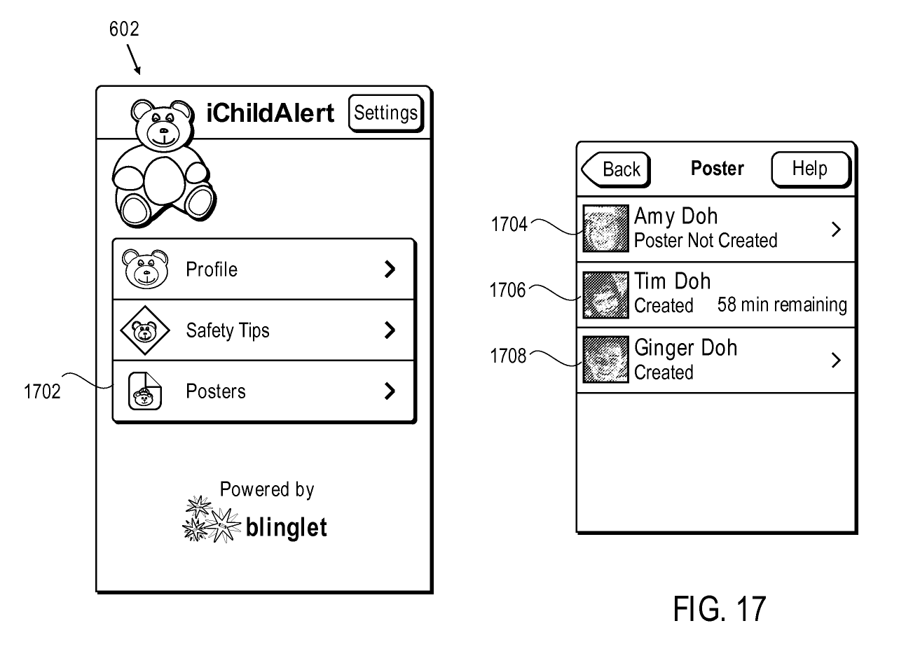

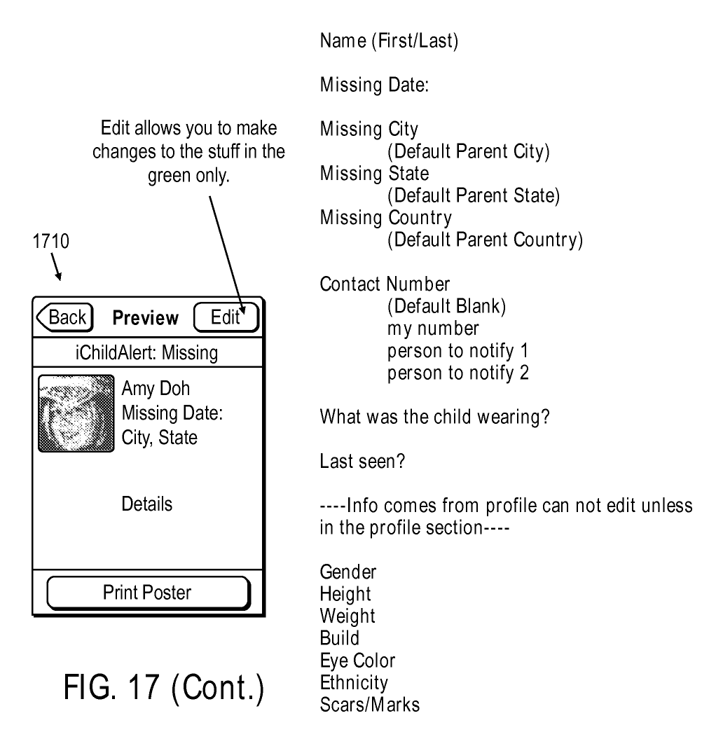

FIG. 17 illustrates the user interface screens involved in creating an emergency notification. From home screen 602, the user may select Posters button 1702, or other user interface element, followed by selecting the appropriate profile (via, e.g., user interface elements 1704, 1706 and 1708) for the missing subject. Subsequently, the corresponding profile information may be uploaded to server 20. Server 20 returns a preview (e.g., within user interface 1710) of the emergency notification, which the user can then edit.

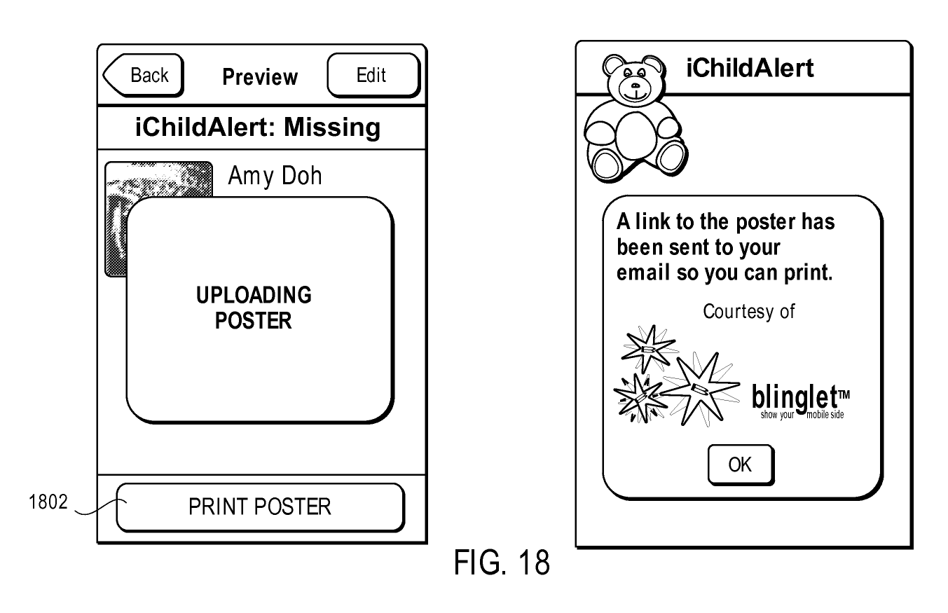

As shown in FIG. 18, once the editing is complete, the user can request printing of the emergency notification (e.g., via Print Poster button 1802) and is subsequently notified that information regarding a site where the poster can be downloaded or the emergency notification website viewed is being transmitted. In some cases, the notification itself may include the link so that it can be viewed/printed directly from the mobile phone. The profile information is preferably automatically removed from the server after a predetermined period of time (e.g., one hour).

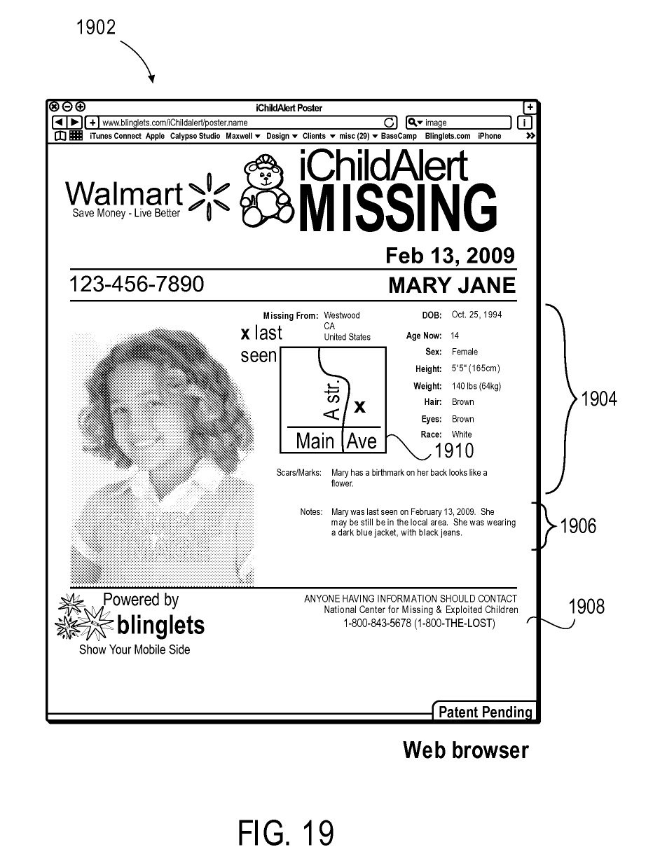

FIG. 19 illustrates example poster 1902 that may be displayed using a Web browser of computing device 2. Alternatively or in addition, posters may be displayed using a WAP browser of mobile device 8. Information displayed on a poster may include attributes 1904, such as the name, date of birth, digital image, age, sex, height, weight, hair, eye color, race and/or scars/marks of the subject. In addition, the poster may include textual description 1906, such as the date the subject became missing and circumstances concerning the disappearance (e.g., person the subject was last seen with, clothing the subject was last seen wearing, etc.). The poster may include a telephone number (e.g., telephone number 1908) for anyone with information (regarding the missing subject) to contact. Further, the poster may include one or more maps (e.g., map 1910) indicating one or more locations where the subject is known, suspected, and/or believed to be last seen. Such location(s) may be designated by an X, O, or other indicator on the one or more maps, as displayed in FIG. 19. In addition or in the alternative to a map, one or more locations where the subject is known, suspected, and/or believed to be last seen may be presented as a street address and/or latitude/longitude coordinates (not illustrated).

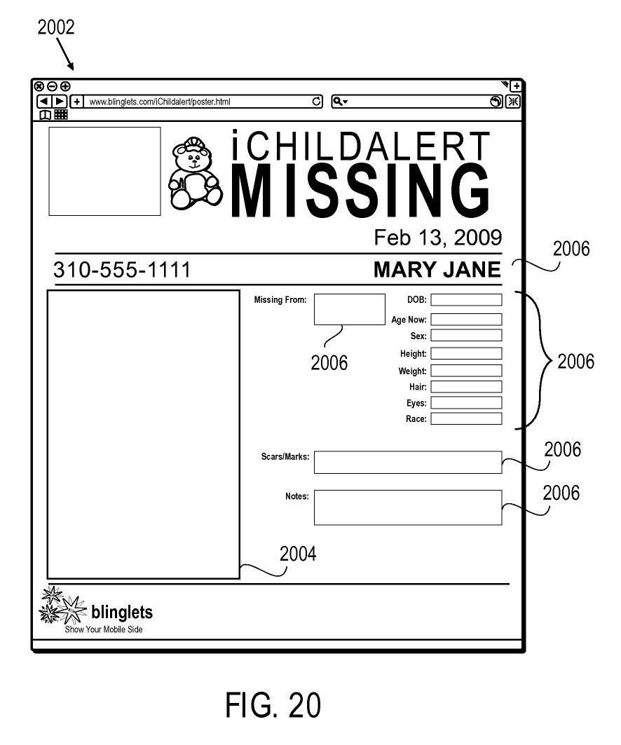

FIG. 20 illustrates an example of a blank emergency notification template 2002, in this case for a poster, with available fields 2004 for the photo of the child, pet, etc., and fields 2006 for information obtained from the profile. In some cases, a map of an area including where a child or pet was last seen may be included.

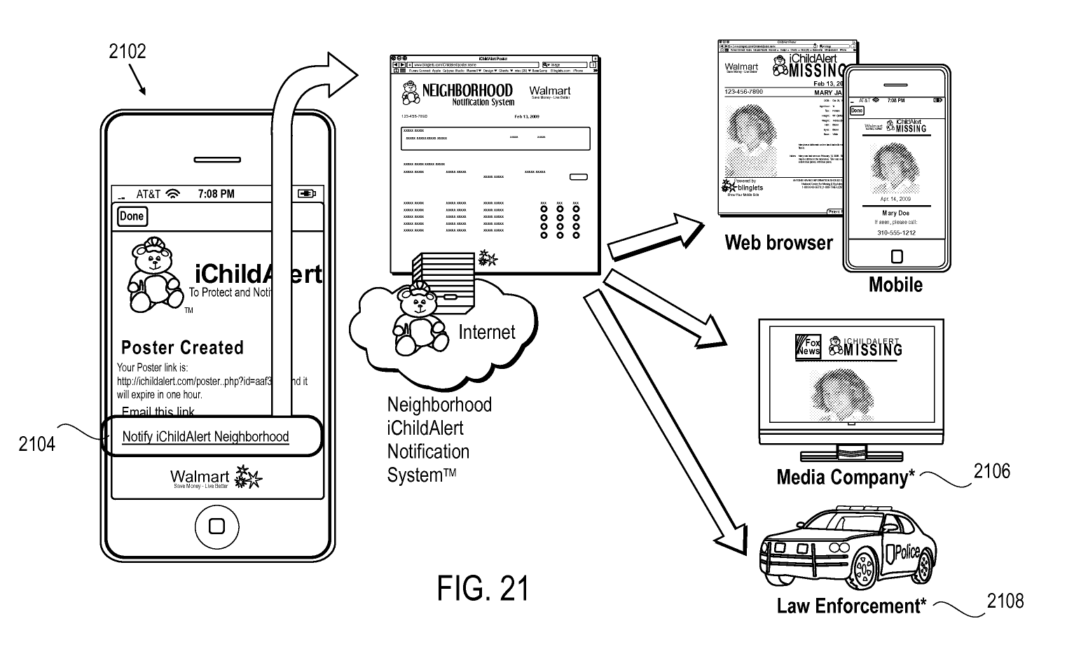

FIG. 21 illustrates an example user interface screen 2102 which may facilitate the user alerting various parties regarding a missing subject. The user may select “Notify iChildAlert Neighborhood” link 2104, or other user interface element, to initiate the process of alerting various parties. A user may then be offered the choice to alert others regarding the missing subject including, but not limited to, other users of application 10, the media (depicted as 2106), and law enforcement (depicted as 2108).

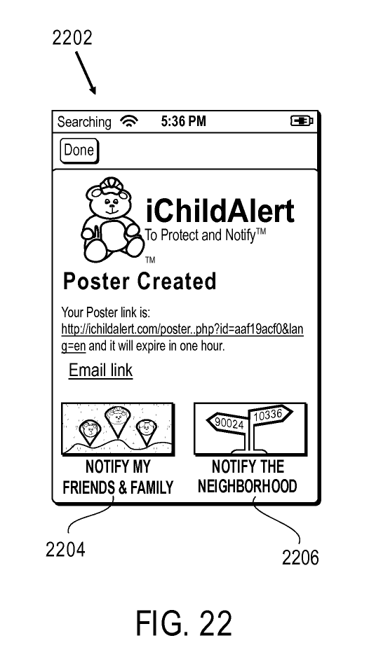

FIG. 22 illustrates another example user interface screen 2202 which may facilitate the user alerting various parties regarding a missing subject. In this example, the user may select user interface element 2204 to notify friends and family (of either of the missing subject or the user) or user interface element 2206 to notify the neighborhood. Notifying friends and families may allow the user to notify a group of individuals that the user has pre-selected and/or input to application 10 prior to the subject becoming missing. Notifying the neighborhood may allow the user to notify parties similar to those mentioned above (including, e.g., other users of application 10, the media, and law enforcement), or other parties such as restaurant owners, gas station owners, education facility personnel, etc. Notifying the neighborhood may also allow the user to notify other application users with a certain ZIP code.

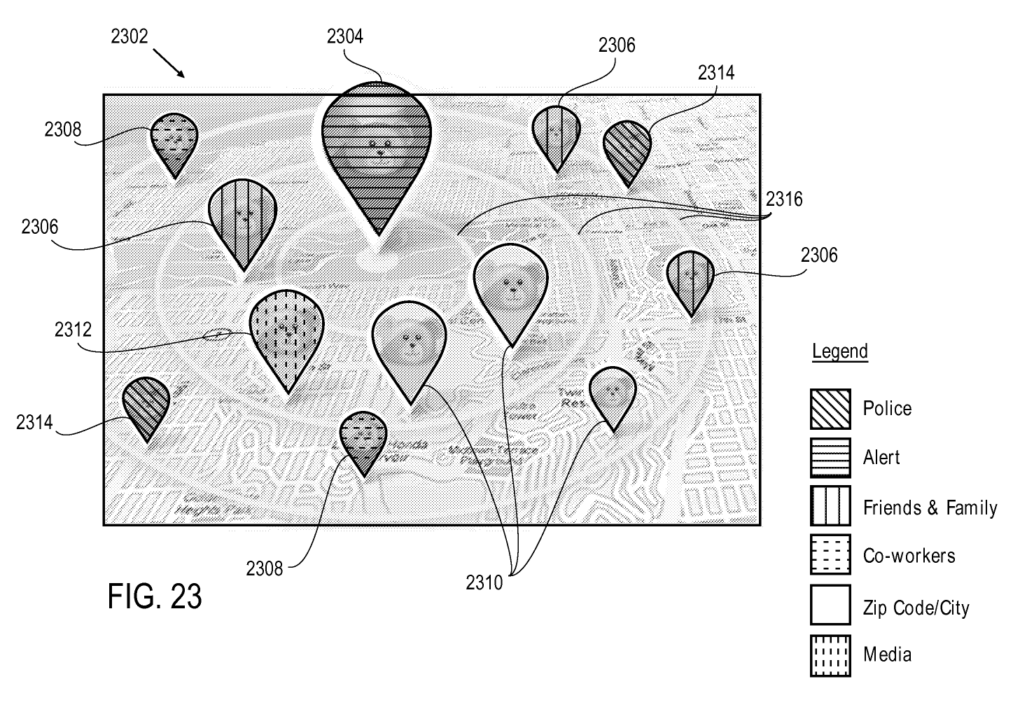

FIG. 23 illustrates yet another example user interface screen 2302 which may facilitate the user alerting various parties regarding a missing subject. Depicted in FIG. 23 is a map indicating the location of various individual/parties some of whom are suggested candidates for the user to alert. The locations may be indicated by inverted teardrop shapes, or other user interface elements. In FIG. 23, the interface elements may further be labeled (using different hash marks as illustrated or different colors) to identify the type of individuals/parties. One or more user interface elements 2304 may denote a location associated with the missing subject (e.g., location missing subject was last seen), designated as “Alert” in FIG. 23. One or more user interface elements 2306 may denote the location of friends and family (e.g., of the user and/or the missing subject). One or more user interface elements 2308 may denote the location of co-workers (e.g., of the user and/or the missing subject). One or more user interface elements 2310 may denote the location of individuals/parties located within a geographical area delimited by one or more ZIP codes and/or one or more cities. One or more user interface elements 2312 may denote the location of media personnel. Furthermore, one or more user interface elements 2314 may denote the location of police stations and/or law enforcement officers. The user may alert one or more of the aforementioned individuals/parties by selecting the appropriate user interface elements (e.g., in FIG. 23, the inverted teardrop shapes).

Also shown in FIG. 23 are various rings 2316 delimiting geographical areas within a certain radius of a location associated with the missing subject. The user may choose to alert all or some of the individuals/parties within a certain ring. As mentioned previously, other geometric shapes may be used to delimit geographical areas (e.g., circles, squares, triangles, etc.). In another embodiment of the invention, FIG. 23 may denote the location of individual/parties who have already been alerted through the various aforementioned means.

In one embodiment of the invention, alerting and/or notifying an individual/party includes sending (via, e.g., MMS, e-mail, etc.) a poster of the missing subject to the individual/party. Alternatively or in addition, an alert may include a text message (sent or displayed, e.g., via an SMS, an e-mail, a blog posting, an electronic highway informational sign). In yet another embodiment, an alert may include a URL link (sent, e.g., via SMS, e-mail, etc.) that allows access to more information regarding the alert (e.g., allowing access to a poster or police report). In yet another embodiment, an alert may include an audio and/or visual message (e.g., a telephone call, video, streaming video, television report, etc.). Posters may also be printed for display.

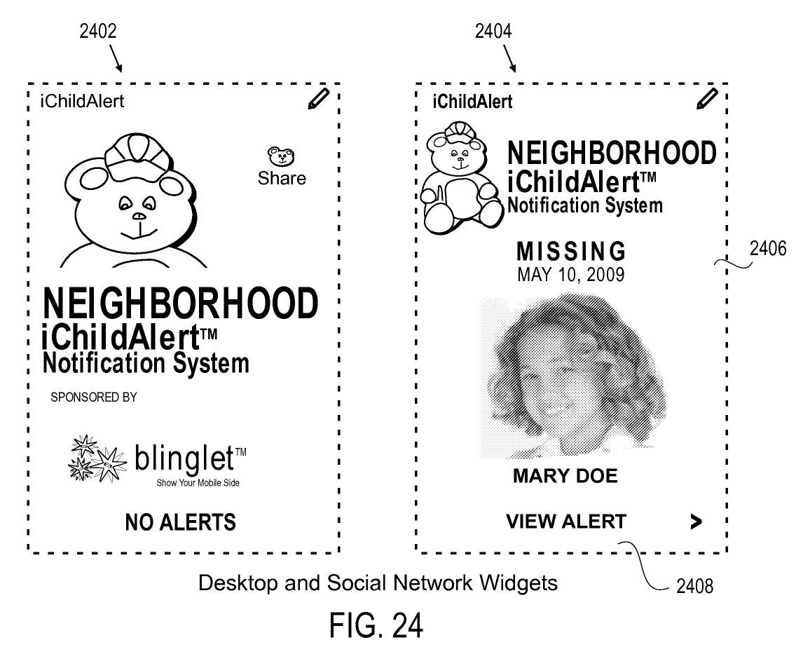

In the event that an alert is sent to other application and/or social networking users, user interface elements (e.g., widgets) displayed via the desktop screen of computing device 2, Web browser of computer device 2, a social networking website, and/or WAP browser of mobile device 8 may be updated. For example as depicted in FIG. 24, a user interface element may initially have no alerts (left image 2402 of FIG. 24) and be updated to display one or more alerts 2406 of missing subjects (right image 2404 of FIG. 24). Upon the user interface element displaying an alert 2406, a user may be given the choice to view more details regarding the alert (via, e.g., VIEW ALERT button 2408).

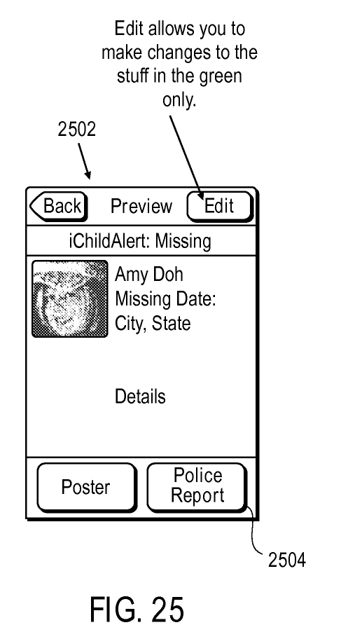

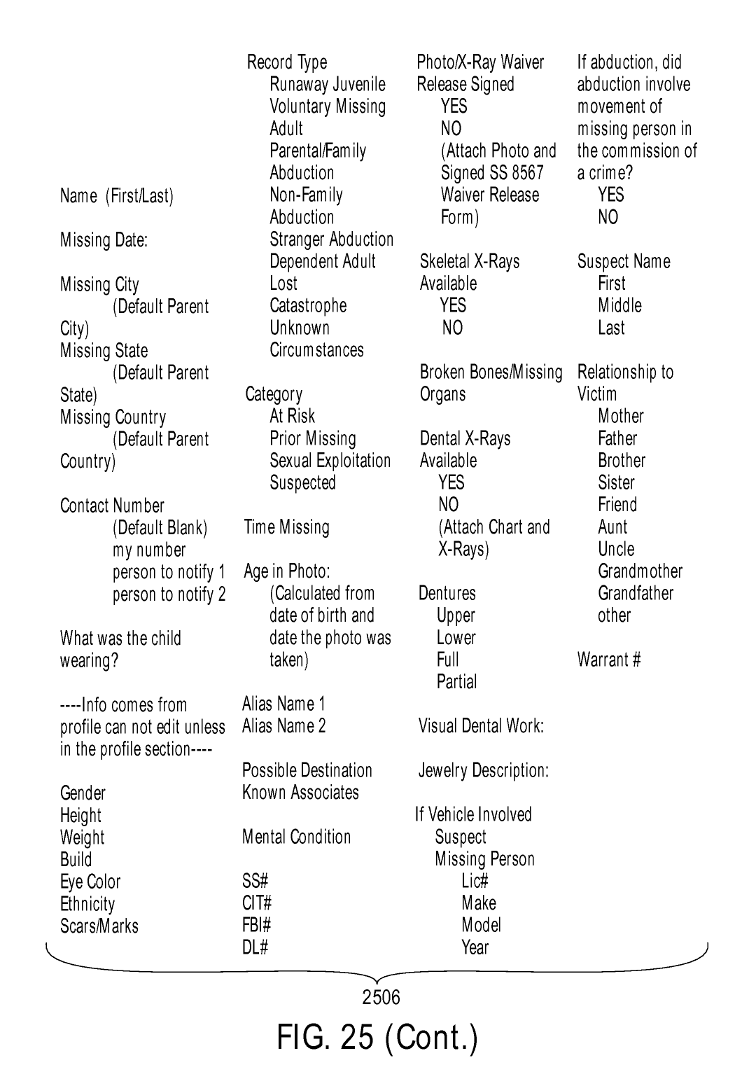

Now referring to FIG. 25, in some embodiments of the invention in addition to creating an emergency notification, parents, guardians or others may be afforded the opportunity to fill out police reports or similar law enforcement notices. For example, from preview screen 2502, or other user interface screen, the user may select an appropriate user interface element (e.g., Police Report button 2504) to create a police report, which report may include a number of fields 2506, some of which are editable. Many of fields 2506 can be populated directly from the profile information provided by the user. For other fields, using virtual keyboard 912 of the iPhone (or a physical or virtual keyboard of another device) the user can provide input (e.g., either by typing an entry or selecting a pre-populated entry from a list). Alternatively or in addition, information can be input from computing device 2 and subsequently transferred to mobile device 8 (through any of the above-mentioned transferring techniques, e.g., direct transfer from computing device 2 to mobile device 8, or transfer from computing device 2 through server 20 to mobile device 8) to populate fields of the police report.

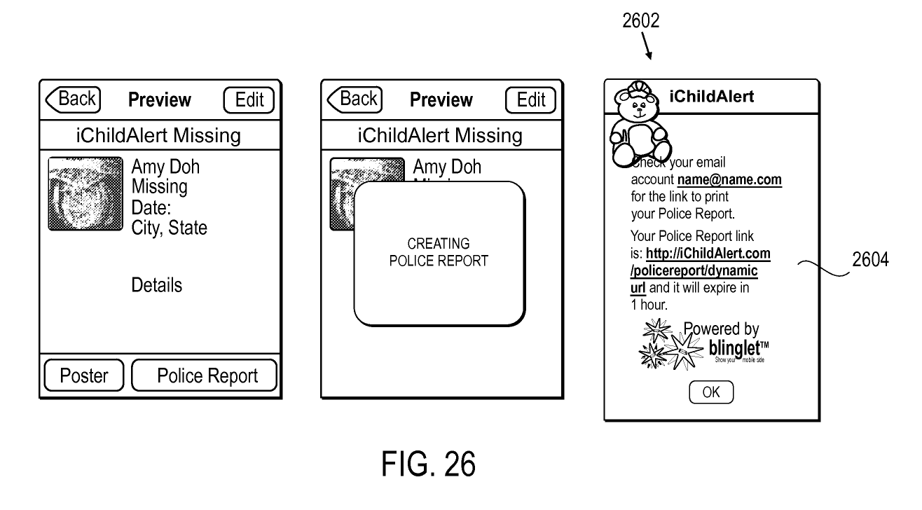

Among the fields 2506 for such a report may be identification information for the missing child, emergency contact information, an indication of whether or not the child has a prior police record, details regarding the child's disappearance, aliases, known associates and possible destinations (e.g., if a run away), mental or physical conditions, social security and/or driver's license numbers, jewelry or clothing, identifying information of vehicles, wants or warrants, etc. Furthermore, electronic files 302 (e.g., dental records, dental X-Ray, skeletal X-Ray, fingerprint records) can be attached to the police report to assist law enforcement in locating the missing subject. The police report can be made available for download at a specified host in a fashion similar to the emergency notification. See, e.g., FIG. 26, which illustrates an example of a notification screen 2602 providing the user with link 2604 to obtain a copy of the police report.

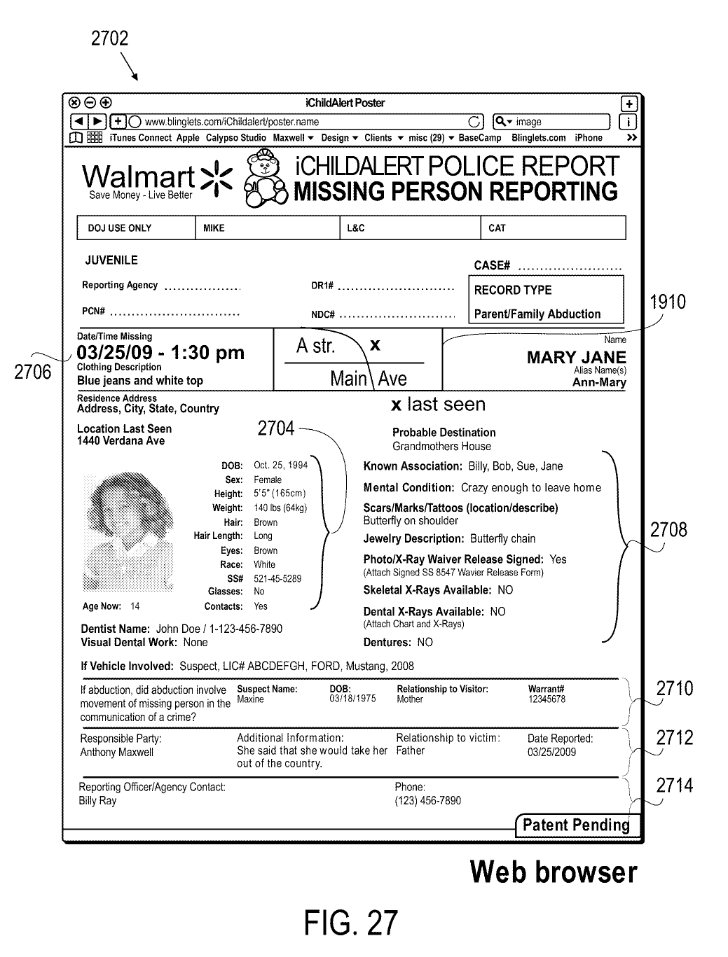

FIG. 27 illustrates an example police report 2702 that may be printed or displayed using a Web browser of computing device 2. Alternatively, or in addition, police reports may be displayed using a WAP browser of mobile device 8. Information displayed on a police report may include attributes 2704, such as the name, date of birth, digital image, age, sex, height, weight, hair, eye color, race and/or scars/marks of subject. In addition, the police report may include the date the subject became missing (e.g., date 2706) and notes regarding circumstances concerning the disappearance (e.g., person the subject was last seen with, clothing the subject was last seen wearing, location the subject was last seen, location the subject was last believed to have been etc.). As described previously, the location the subject was last seen and/or last believed to have been may be indicated via a map (e.g., map 1910), a street address, and/or latitude/longitude coordinates. Further, the police report may include description 2708 such as the people the subject is known to associate with (e.g., family and friends), any mental conditions, any a scars/mark/tattoos, any jewelry the subject is known to wear, whether the subject wears dentures, whether fingerprint records are available, skeletal/dental X-Rays are available, whether law enforcement is permitted to access one or more electronic records of the subject, etc. In addition, the police report may include information 2710 regarding one or more individuals (e.g., suspects) that are associated with the disappearance of the subject, including the suspect's name, date of birth, relation to missing subject, and any warrant numbers on the suspects. The police report may include information 2712 regarding one or more reporting parties, including name, date of birth, relationship to the missing subject. Lastly, the police report may include information 2714 such as a reporting officer/agency contact name and contact information.

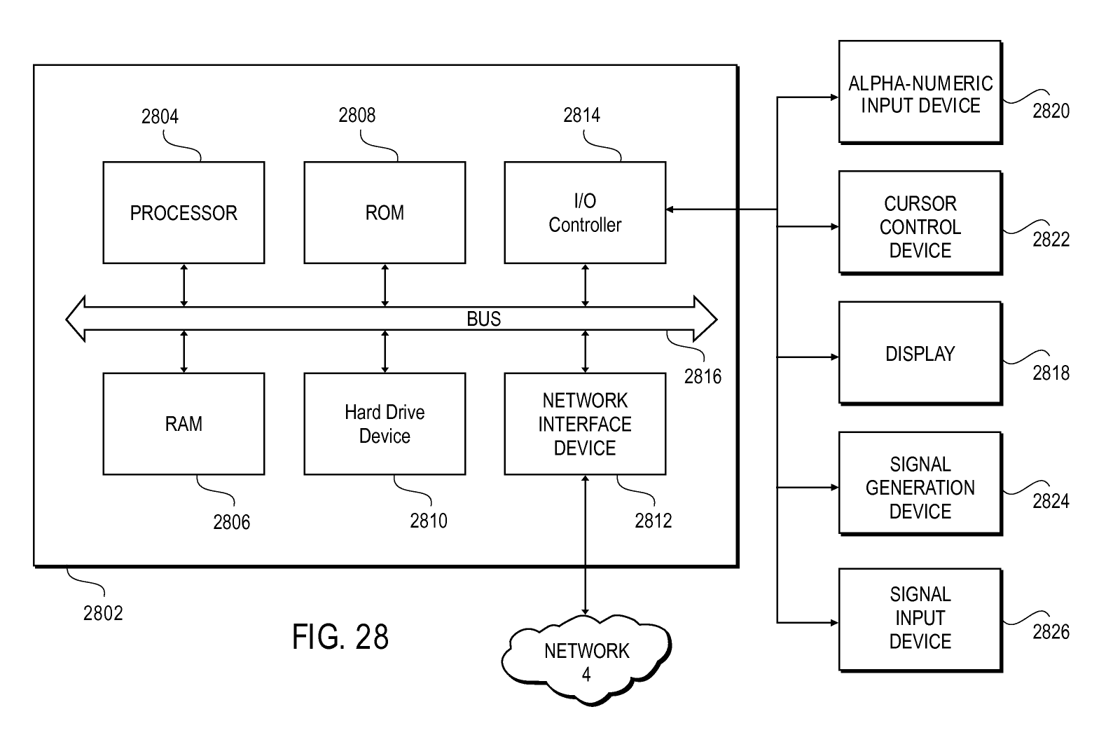

FIG. 28 of the accompanying drawings illustrates computer system 2802, also known as a data processing system. The operations, processes, modules, methods, and systems described and shown in the accompanying figures of this disclosure are intended to operate on one or more of computer systems 2802 as sets of instructions (e.g., software), also known as computer-implemented methods. Computer system 2802 is generally representative of computing device 2, mobile device 8 (e.g., a mobile cellular device, PDA, satellite phone, mobile VoIP device, iPhone, handheld device), and server 20. The computer system includes at least one processor 2804 (e.g., a Central Processing Unit (CPU), a Graphics Processing Unit (GPU) or both), Random Access Memory 2806 (RAM) (e.g., flash memory, Dynamic Random Access Memory (DRAM), Static Random Access Memory (SRAM), Synchronous DRAM (SDRAM), etc.), Read Only Memory (ROM) 2808 (e.g., Erasable Programmable Read Only Memory (EPROM), Electrically Erasable Programmable Read Only Memory (EEPROM)), a Hard Drive Device 2810 whether built-in, internal, external and/or removable (e.g., USB device, magnetic storage device, optical storage device, compact disk (CD) read/write device, digital video disk (DVD) read/write device, floppy disk read/write device, etc.), a network interface device, and input/output (I/O) controller 2814, which are communicatively coupled with one another other via bus 2816.

I/O controller 2814 may interface computer system 2802 with display 2818 (e.g., Liquid Crystal Display (LCD) or a Cathode Ray Tube (CRT) or a touch screen), alpha-numeric input device 2820 (e.g., a keyboard, phone pad, touch screen), cursor control device 2822 (e.g., a mouse, joy-stick, touch-pad), signal generation device 2824 (e.g., a speaker), and signal input device 2826 (e.g., a microphone, camera, fingerprint scanner, web-cam).

Network interface device 2812 may include, for example, a Network Interface Card (NIC), Ethernet card and/or dial-up modem, and may be communicatively coupled to network 4. In addition, network interface device 2812 may be a wireless network interface device in the case of mobile device 8 communicatively coupled to network 4 (e.g., a cellular, VoIP and/or WiFi network). If computer system 2802 is server 20, alpha-numeric input device 2820, cursor control device 2822, display 2818, signal generation device 2824 and/or signal input device 2826 may be omitted.

One or more of the ROM, RAM, and Hard Drive Device includes a computer-readable storage medium on which is stored one or more sets of computer-readable instructions (e.g. software) embodying one or more of the operations described herein. The computer-readable storage medium may include a single medium or multiple media (e.g., a centralized or distributed database, and/or associated caches and servers) that store the one or more sets of computer-readable instructions. The term “computer-readable storage medium” shall also be taken to include any physical/tangible medium that is capable of storing or encoding a set of instructions for execution by processor 2804.

As used herein, the term mobile device includes any such device, including for example, mobile telephones, smart phones, personal digital assistants, portable computers, and in-car terminals. For example, In general, a terminal in a car receives general traffic information from a traffic information providing system. For example, the present invention is suitable for use with in-car systems such as the vehicle information and communication system (VICS) and data radio channels (e.g., DARC) which are used for conveying information such as real-time traffic information. Profile information concerning missing children, pets, etc., may be provided by servers to distribution outlets that broadcast information for use by in-car systems and the information may be presented via such systems similar to the way in which traffic and other information is commonly presented. This may include, in some cases, audio announcements concerning missing children, and/or visual indications of same superimposed over maps displayed on an in-car navigation system. Such in-car systems typically have access to location information provided by in-car GPS receivers and so the missing child information may be tagged with location information so that it is displayed when the in-car system determines that the vehicle is presently in an area near to where the disappearance has occurred. Other information, such as updates or audio/video information provided by neighborhood watch or similar organizations could likewise be provided to in-car systems. For those vehicles equipped with two-way data channels (e.g., in-car telephones or data links), information could be uploaded from occupants of the vehicles, for example, as search areas are canvassed or as new information concerning the missing subject is determined.

Thus, methods and systems for producing emergency notifications and, in one embodiment, an application for a mobile phone or the like, which allows parents to quickly produce an emergency notification for a missing child, have been described. The scope of present invention is described by the following claims and their equivalents.

I claim:

1. A computer-readable storage medium storing computer-readable instructions, which instructions, when executed by a processor, cause the processor to perform a process, the process comprising:
receiving on a mobile device profile information associated with a subject;
uploading the profile information from the mobile device to a server;
displaying on the mobile device a draft of an emergency notification prepared at the server and based on the uploaded profile information; and
transmitting a request from the mobile device to the server for a final version of the emergency notification to be prepared at the server.

2. The computer-readable storage medium of claim 1, wherein the profile information is received at the mobile device before the subject becomes missing.

3. The computer-readable storage medium of claim 1, wherein the profile information is uploaded from the mobile device to the server after the subject becomes missing.

4. The computer-readable storage medium of claim 1, further comprising:
after displaying the draft emergency notification, receiving on the mobile device additional information to be included in the final version of the emergency notification;
uploading from the mobile device to the server the additional information; and
displaying at the mobile device information regarding the availability of the final version of the emergency notification responsive to receipt of the additional information at the server.

5. The computer-readable storage medium of claim 1, further comprising:
before the profile information is received at the mobile device, uploading the profile information from a computing device to the server; and
upon the profile information being received at the server, automatically downloading the profile information from the server to the mobile device.

6. The computer-readable storage medium of claim 1, further comprising after receiving the profile information regarding the subject, displaying a user interface element which indicates that the profile information requires updating.

7. The computer-readable storage medium of claim 1, wherein the profile information includes an electronic file storing information associated with the subject.

8. The computer-readable storage medium of claim 7, wherein the electronic file includes one or more of a digital image, a digital video, fingerprint records, medical records, X-Ray images, Computer Tomography-Scans, Magnetic Resonance Images, dental records, and information concerning the DNA sequence of the subject.

9. The computer-readable storage medium of claim 1, wherein the subject is one or more of a human child, a human adult, an animal, a pet, and an inanimate object.

10. The computer-readable storage medium of claim 1, wherein the emergency notification is one or more of a poster, a police report, a text message, a website, a telephone call, an e-mail, a blog posting, a video, an electronic highway informational sign, and a television report.

11. The computer-readable storage medium of claim 1, wherein the emergency notification includes one or more of an image of the subject, an attribute that can be used to identify the subject, a location the subject was last seen, and contact information to be used upon the subject being located.

12. A computer-implemented method, comprising:
receiving on a mobile device profile information associated with a subject;
uploading the profile information from the mobile device to a server;
displaying on the mobile device a draft of an emergency notification prepared at the server and based on the uploaded profile information; and
transmitting a request from the mobile device to the server for a final version of the emergency notification to be prepared at the server.

13. A mobile device, comprising:
a memory configured to store computer-readable instructions;
a network interface device; and
a processor communicatively coupled to said memory and said network interface device, said computer-readable instructions, when executed by the processor, cause the processor to perform a process, the process comprising:
receiving on the mobile device profile information associated with a subject;
uploading the profile information from the mobile device to a server;
displaying on the mobile device a draft of an emergency notification prepared at the server and based on the uploaded profile information; and
transmitting a request from the mobile device to the server for a final version of the emergency notification to be prepared at the server.

14. The mobile device of claim 13, wherein the mobile device is an iPhone or Blackberry.

15. A computer-readable storage medium storing computer-readable instructions, which instructions, when executed by a processor, cause the processor to perform a process, the process comprising:
receiving from a handheld device and at a server, profile information associated with a subject;
generating at the server an emergency notification from the profile information;
receiving a request from the handheld device and at the server, to transmit the emergency notification; and
transmitting from the server the emergency notification so as to facilitate locating the subject.

16. The computer-readable storage medium of claim 15, further comprising:
receiving information specifying one or more individuals to be alerted in response to the subject becoming missing; and
wherein transmitting the emergency notification includes transmitting the emergency notification to the one or more individuals.

17. The computer-readable storage medium of claim 15, wherein the subject is one or more of a human child, a human adult, an animal, a pet, and an inanimate object.

18. The computer-readable storage medium of claim 15, wherein the emergency notification is one or more of a poster, a police report, a text message, a website, a telephone call, an e-mail, a blog posting, a video, an electronic highway informational sign, and a television report.

19. The computer-readable storage medium of claim 15, wherein the profile information is automatically removed from the server after a predetermined period of time from when the profile information is uploaded to the server.

20. A server, comprising:
a memory configured to store computer-readable instructions;
a network interface device; and
a processor communicatively coupled to said memory and said network interface device, said computer-readable instructions, when executed by the processor, cause the processor to perform a process, the process comprising:
receiving from a handheld device and at the server, profile information associated with a subject;
generating at the server an emergency notification from the profile information;
receiving a request from the handheld device and at the server, to transmit the emergency notification; and
transmitting from the server the emergency notification so as to facilitate locating the subject.

21. A computer-implemented method, comprising:
providing, via a mobile device, profile information associated with a subject;
uploading the profile information from the mobile device to a server;
preparing, at the server and based on the uploaded profile information, an identification card for the subject of the profile; and
transmitting an electronic file representing the identification card prepared at the server from the server to the mobile device.
